(19) United States
(12) Patent Application Publication
(10) Pub. No.: US 2025/0291941 A1
(43) Pub. Date: Sep. 18, 2025

(54) METHOD FOR PROCESSING TRANSACTION OF BLOCKCHAIN, RELATED APPARATUS, MEDIUM, AND PRODUCT

(71) Applicant: TENCENT TECHNOLOGY (SHENZHEN) COMPANY LIMITED, Shenzhen (CN)

(72) Inventor: Gengliang ZHU, Shenzhen (CN)

(73) Assignee: TENCENT TECHNOLOGY (SHENZHEN) COMPANY LIMITED, Shenzhen (CN)

(21) Appl. No.: 19/226,341

(22) Filed: Jun. 3, 2025

Related U.S. Application Data
(63) Continuation of application No. PCT/CN2023/137030, filed on Dec. 7, 2023.

(30) Foreign Application Priority Data
May 18, 2023 (CN) 202310566770.1

(51) Int. Cl. G06F 21/60; G06F 16/22

(52) U.S. Cl. CPC G06F 21/602; G06F 16/2255

(57) ABSTRACT

A method for processing a transaction of a blockchain includes acquiring an added first target block from first blocks of a first blockchain that forbids external access to a target consensus network, wherein the first target block is generated by the target consensus network and is configured for recording a first transaction of a target type from a local consensus network; acquiring a first target transaction and a first block header from the first target block; acquiring first verification information corresponding to the first target transaction; performing upload verification on the first target transaction based on the first target transaction, the first verification information, and the first block header; acquiring transaction result data of the first target transaction if the upload verification succeeds; and transmitting the transaction result data to a subscription node for the local consensus network to acquire the transaction result data from the subscription node.

### CROSS-REFERENCE TO RELATED APPLICATIONS

This application is a continuation application of International Application No. PCT/CN2023/137030 filed on Dec. 7, 2023, which claims priority to Chinese Patent Application No. 202310566770.1 filed with the China National Intellectual Property Administration on May 18, 2023, the disclosures of each being incorporated by reference herein in their entireties.

### FIELD

The present disclosure relates to the field of blockchains, and to a method for processing a transaction of a blockchain.

### BACKGROUND

In a current blockchain hierarchical consensus system, the local consensus network uploads locally generated transactions to a blockchain in plaintext. For security, some types of transactions are not expected to be known to third parties in plaintext on the blockchain. Hence, transactions of the target type that are not expected to be disclosed in plaintext on the blockchain are transmitted to the target consensus network and recorded on the target blockchain, and the target blockchain forbids external access to the target consensus network. Because the target blockchain forbids the external access, verification and query by the local consensus network become difficult. How to perform trusted upload result interaction without reading information of the target blockchain has become a difficult problem.

### SUMMARY

According to an aspect of the disclosure, a method for processing a transaction of a blockchain, performed by a target consensus network, includes acquiring an added first target block from one or more first blocks of a first blockchain, wherein the first target block is generated by the target consensus network and is configured for recording a first transaction of a target type from a local consensus network, and wherein the first blockchain forbids external access to the target consensus network; acquiring a first target transaction and a first block header from the first target block; acquiring first verification information corresponding to the first target transaction; performing upload verification on the first target transaction based on the first target transaction, the first verification information, and the first block header; acquiring transaction result data of the first target transaction if the upload verification succeeds; and transmitting the transaction result data to a subscription node for the local consensus network to acquire the transaction result data from the subscription node.

According to an aspect of the disclosure, an apparatus for processing a transaction of a blockchain, located in a target consensus network, includes at least one memory configured to store computer program code; and at least one processor configured to read the program code and operate as instructed by the program code, the program code including first acquisition code configured to cause at least one of the at least one processor to acquire an added first target block from one or more first blocks of a first blockchain, wherein the first block is generated by the target consensus network and is configured for recording a first transaction of a target type from a local consensus network, and wherein the first blockchain forbids external access to the target consensus network; second acquisition code configured to cause at least one of the at least one processor to acquire a first target transaction and a first block header from the first target block; third acquisition code configured to cause at least one of the at least one processor to acquire first verification information corresponding to the first target transaction; upload verification code configured to cause at least one of the at least one processor to perform upload verification on the first target transaction based on the first target transaction, the first verification information, and the first block header; fourth acquisition code configured to cause at least one of the at least one processor to acquire transaction result data of the first target transaction if the upload verification succeeds; and first transmission code configured to cause at least one of the at least one processor to transmit the transaction result data to a subscription node for the local consensus network to acquire the transaction result data from the subscription node.

According to an aspect of the disclosure, a non-transitory computer-readable storage medium, storing computer code which, when executed by at least one processor, causes the at least one processor to at least acquire an added first target block from one or more first blocks of a first blockchain, wherein the first block is generated by the target consensus network and is configured for recording a first transaction of a target type from a local consensus network, and wherein the first blockchain forbids external access to the target consensus network; acquire a first target transaction and a first block header from the first target block; acquire first verification information corresponding to the first target transaction; perform upload verification on the first target transaction based on the first target transaction, the first verification information, and the first block header; acquire transaction result data of the first target transaction if the upload verification succeeds; and transmit the transaction result data to a subscription node for the local consensus network to acquire the transaction result data from the subscription node.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 shows a schematic architecture diagram of a blockchain hierarchical consensus network system to which some embodiments is applied;

FIG. 2 shows a schematic diagram of applying a method for processing a transaction of a blockchain according to some embodiments to a resource transfer transaction upload scenario;

FIG. 3 shows a flowchart of a method for processing a transaction of a blockchain according to some embodiments;

FIG. 4 shows a first flowchart of operation 310 of acquiring a first target block by using a first blockchain height counter in FIG. 3;

FIG. 5A shows a schematic diagram of some embodiments of operation 420 in FIG. 4;

FIG. 5B shows a schematic diagram of some embodiments of operation 430 in FIG. 4;

FIG. 6 shows a second flowchart of operation 310 of acquiring the first target block by using the first blockchain height counter in FIG. 3;

FIG. 7 shows a schematic diagram of some embodiments of operation 610 in FIG. 6;

FIG. 8 shows a flowchart of operation 310 of acquiring the first target block by using a subscription condition in FIG. 3;

FIG. 9A shows a schematic diagram of a data structure of a first subscription request having a first subscription condition;

FIG. 9B shows a schematic diagram of a data structure of a first subscription request having a first subscription condition and a subscription deadline;

FIG. 10 shows a flowchart of acquiring a first subscription request through integration of a plurality of second subscription requests;

FIG. 11 shows a schematic diagram of a data structure of a second subscription request having a second subscription condition;

FIG. 12 shows a schematic diagram of some embodiments of generating a first subscription condition based on a plurality of second subscription conditions;

FIG. 13 shows a schematic diagram of some embodiments of transmitting transaction result data to subscription nodes corresponding to different transaction subtypes;

FIG. 14 shows a schematic diagram of some embodiments of transmitting transaction result data to subscription nodes corresponding to different object sets;

FIG. 15 shows a flowchart of acquiring a first transaction based on first priority and second priority;

FIG. 16 shows a schematic diagram of some embodiments of acquiring a first transaction based on first priority and second priority;

FIG. 17 shows a flowchart of some embodiments of operation 1520 in FIG. 15;

FIG. 18 shows a flowchart of some embodiments of operation 340 in FIG. 3;

FIG. 19 shows a schematic diagram of some embodiments of performing first sub-verification based on a first block header;

FIG. 20 shows a flowchart of some embodiments of operation 1830 in FIG. 18;

FIG. 21A shows a schematic diagram of some embodiments of operation 2010 of generating a first tree in FIG. 20;

FIG. 21B shows a schematic diagram of operation 2020 of acquiring a first bypass feature of a first path in FIG. 20;

FIG. 22 shows a flowchart of some embodiments of operation 340 of using a trusted execution environment in FIG. 3;

FIG. 23 shows a flowchart of some embodiments of operation 360 in FIG. 3;

FIG. 24 shows a flowchart of a method for processing a transaction of a blockchain according to some embodiments;

FIG. 25 shows a flowchart of a method for processing a transaction of a blockchain according to some embodiments;

FIG. 26 shows a flowchart of some embodiments of operation 2510 to operation 2520 in FIG. 25;

FIG. 27A shows a schematic diagram of some embodiments of operation 2610 of generating a first tree in FIG. 26;

FIG. 27B shows a schematic diagram of operation 2620 of acquiring a first bypass feature of a first path in FIG. 26;

FIG. 28 shows a flowchart of some embodiments of operation 360 of using a trusted execution environment in FIG. 3;

FIG. 29 shows a multi-end interaction diagram of a detailed embodiment;

FIG. 30 shows a block diagram of an apparatus for processing a transaction of a blockchain according to some embodiments;

FIG. 31 shows a structural diagram of a terminal implementing the method for processing a transaction of a blockchain shown in FIG. 3 according to some embodiments; and

FIG. 32 shows a structural diagram of a server implementing the method for processing a transaction of a blockchain shown in FIG. 3 according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Before some embodiments are further described in detail, the nouns and terms involved in some embodiments are described. The nouns and terms involved in some embodiments are to explain as follows:

Artificial intelligence: it refers to theories, methods, technologies and application systems that use digital computers or machines controlled by digital computers for simulating, extending and expanding human intelligence, perceiving the environment, acquiring knowledge and using knowledge to acquire target results. Artificial intelligence is a comprehensive technology of computer science with attempts to understand the essence of intelligence and produce a new intelligent machine that can respond similarly like the human intelligence. Artificial intelligence is to study design principles and implementation methods of various intelligent machines, and make the machines have functions of perception, reasoning and decision-making. The artificial intelligence technology is a comprehensive subject and involves a wide range of fields, for example, hardware-level technologies and software-level technologies. Basic technologies of artificial intelligence may include technologies such as sensors, dedicated artificial intelligence chips, cloud computing, distributed storage, big data processing technology, operation/interaction systems, and mechatronics. Software technologies of artificial intelligence may include a computer vision technology, a voice processing technology, a natural language processing technology, machine learning/deep learning, for example With research and progress of the artificial intelligence technology, the artificial intelligence technology has been studied and applied to many fields, such as common smart homes, smart wearable devices, virtual assistants, smart speakers, smart marketing, unmanned driving, autonomous driving, unmanned aerial vehicles, robots, smart healthcare, and smart customer service. With art development, the artificial intelligence technology will be applied to more fields and play an increasingly important role.

Blockchain: A blockchain is a novel application mode of computer technologies such as distributed data storage, peer-to-peer transmission (P2P network), consensus mechanisms, and encryption algorithms. The blockchain is essentially a decentralized database, and includes a series of data blocks generated through association by a cryptography method. Each data block includes a batch of transaction information and is configured to verify validity (anti-counterfeiting) of the information and be associated with a previous block.

P2P network: a peer-to-peer network. The P2P network is based on a network protocol. A central node is unto maintain a network state between network nodes. Instead, a node state throughout the network or a connection state of adjacent nodes of each node is maintained through broadcast interaction between each node and adjacent nodes.

The blockchain layering consensus system includes a local consensus network and a global consensus network. A consensus node in the local consensus network performs a blockchain upload operation on locally generated transactions (for example, transactions generated by a subsidiary of a particular group), while the global consensus network performs a blockchain upload operation on a global transaction summarized from the local transactions (for example, a group transaction summarized from the transactions of the subsidiary). The local consensus network and the global consensus network have different blockchains for the upload operations, thus implementing hierarchical governance. The global consensus network may not process a large number of local transactions, and can focus on global governance.

In a current blockchain hierarchical consensus system, the local consensus network uploads locally generated transactions to a blockchain in plaintext. For security, some types of transactions are not expected to be known to third parties in plaintext on the blockchain. Hence, transactions of the target type that are not expected to be disclosed in plaintext on the blockchain are transmitted to the target consensus network and recorded on the target blockchain, and the target blockchain forbids external access to the target consensus network. Because the target blockchain forbids the external access, verification and query by the local consensus network become difficult. How to perform trusted upload result interaction without reading information of the target blockchain has become a difficult problem.

### System Architecture and Scenario Description Applied to Some Embodiments

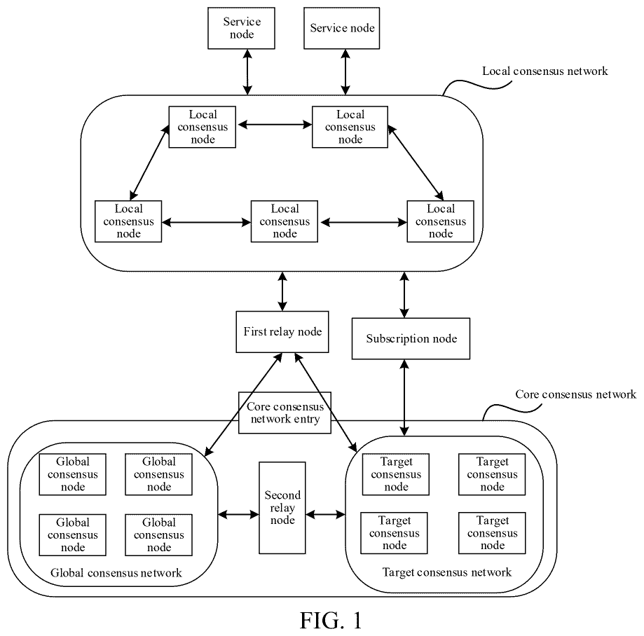

With reference to the blockchain hierarchical consensus network shown in FIG. 1, the blockchain hierarchical consensus network refers to a blockchain network for hierarchical consensus on the transactions. The blockchain hierarchical consensus network includes a service node, a local consensus network, a core consensus network, a first relay node, and a subscription node. The service node refers to a node that generates a local transaction, does not perform upload on the blockchain, but witnesses upload of the local transaction. The local transaction refers to a transaction that affects a local scope. For example, a transaction of a resource aspect of a branch of a group is the local transaction. The local consensus network refers to the network that reaches consensus on and uploads the local transaction. The local consensus network includes a plurality of local consensus nodes. The core consensus network refers to the network that reaches consensus on and uploads the global transaction and a target transaction. The core consensus network includes a global consensus network, a target consensus network, and a second relay node. The global consensus network refers to a network that reaches consensus on and uploads the global transaction deduced from the local transactions. The global consensus network includes a plurality of global consensus nodes. The global transaction refers to a transaction whose nature affects a global scope. For example, a transaction of summarizing resource transfer of the branch of the group is the global transaction. The target consensus network refers to the network that reaches consensus on and uploads the target transaction. The target consensus network records the target transaction on a first blockchain. The target transaction refers to a transaction that is not expected to be accessed or known to a third party. The first blockchain refers to a blockchain of blocks that record the transactions that are not expected to be accessed or known to the third party. The first blockchain is not expected to be accessed externally. If verification information of the blocks recorded on the first blockchain is to be acquired, a request may be made of the target consensus node that records the first blockchain in the target consensus network.

Since the target transaction is the transaction is not expected to be accessed or known to the third party, consent from an object generating the target transaction is to be sought before the target transaction is uploaded. When the object generates and transmits the target transaction to the local consensus network for being uploaded, a query box may be displayed to the object to ask whether the object consents to upload the target transaction. If the object does not consent, some embodiments may not be implemented, or part of the transaction with upload consent is uploaded.

The first relay node is an interface node between the local consensus node and the global consensus node, and plays the role of forwarding the local transactions generated by the local consensus network to the global consensus network. The global consensus network summarizes the local transactions into the global transaction and uploads the global transaction. The second relay node is an interface node between the target consensus network and the global consensus network, and plays a role in forwarding blockchain height information generated in the target consensus network after the local transactions of the target type are recorded in the blockchain to the global consensus network. The global consensus network forwards the blockchain height information to the local consensus network to inform the local consensus network that the local transactions of the target type are successfully uploaded. The subscription node is an interface node between the local consensus network and the target consensus network, and plays the roles of acquiring, from the target consensus network, transaction result data generated after the local transactions of the target type are recorded in the target blockchain, and transmitting the transaction result data to the local consensus network.

The target consensus node, the local consensus node, and the global consensus node are all consensus nodes, and are also referred to as blockchain nodes. The consensus node or the blockchain node may be servers in the blockchain network or user terminals accessing the blockchain network, and forms of the consensus node or the blockchain node are not limited herein. The first relay node and the second relay node are interface nodes. The first relay node and the second relay node may be independent devices, such as separate computers or servers. The first relay node and the second relay node may be part of an independent device, such as a virtual machine partitioned on the server. forms of the first relay node and the second relay node are not limited herein.

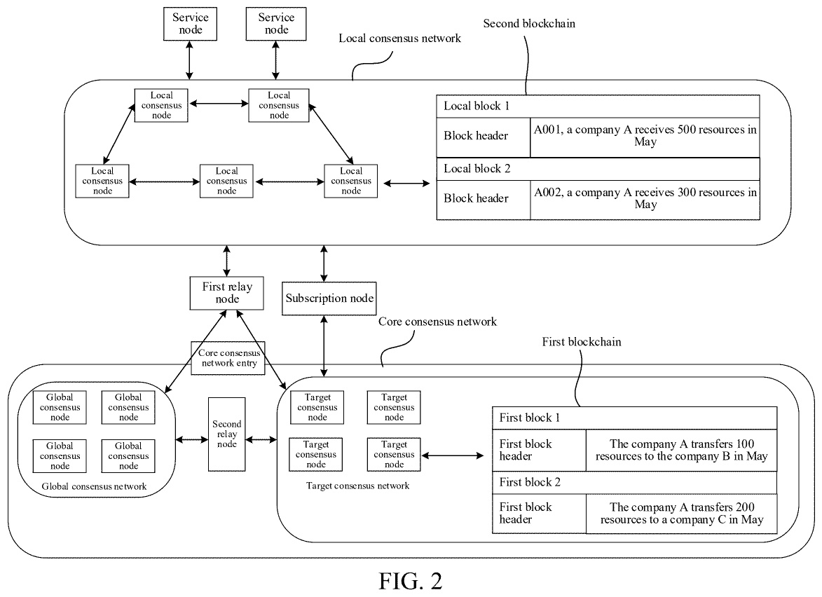

Some embodiments may be applied to various scenarios, such as a scenario of resource transfer transaction upload in FIG. 2.

With reference to FIG. 2, a difference between FIG. 2 and FIG. 1 lies in that FIG. 2 further shows a second blockchain maintained by the local consensus network and a first blockchain maintained by the target consensus network. The second blockchain and the first blockchain are the blockchain described above. A process of recording the local transactions into the second blockchain is as follows:

The service node generates the local transaction based on an operation behavior of the object, and transmits the local transaction and a digital signature of the service node to an adjacent local consensus node on the local consensus network. The local consensus node conveniently verifies authenticity of the local transaction. During verification, the local consensus node verifies the digital signature with a public key of the service node to acquire a first digest value of the local transaction, and performs digest computation on the local transaction with a digest algorithm to acquire a second digest value of the local transaction. The first digest value is compared with the second digest value. If the first digest value and the second digest value are equal, the verification passes, and the local transaction is a real transaction generated by the service node.

After the verification passes, the local transaction and other local transactions transmitted by the service node are accumulated. When accumulation reaches a particular level (for example, a number of accumulated transactions reaches a particular threshold, or accumulation time reaches a particular threshold), these local transactions are packaged into the local blocks and transmitted to other target consensus nodes in the local consensus network for consensus. After the consensus is reached successfully, the local consensus nodes record the local blocks on the second blockchains maintained by the local consensus nodes respectively.

With reference to FIG. 2, the second blockchain is composed of three local blocks, and two local transactions are recorded on local blocks 1 to 2, namely “A001, a company A receives 500 resources in May” and “A002, the company A receives 300 resources in May”. These two local transactions on the second blockchain are forwarded to the global consensus node of the global consensus network through the first relay node, and the global consensus node generates the global transaction based on these two local transactions, for example, “the company A receives 800 invoice resources totally in May”. A third block is generated from the global transaction and the third block is recorded on a third blockchain. A process of recording the global transaction on the third blockchain is similar to a process of recording the local transactions on the second blockchain described abovein.

With reference to FIG. 2, the first blockchain is composed of two local blocks, and two target transactions are recorded on first blocks 1 to 2, namely “the company A transfers 100 resources to the company B in May” and “the company A transfers 200 resources to a company C in May”. Since these two target transactions involve resource transfer between different companies and are not allowed to be disclosed to the outside, these two target transactions are recorded on the first blockchain. The first blockchain is unavailable to the outside, thus improving upload security of the target transaction. A process of recording the target transaction on the first blockchain is similar to a process of recording the local transactions on the second blockchain described abovein.

Due to the fact that the first blockchain forbids external access, the local consensus network cannot perform upload result interaction with the target consensus network on the premise of guaranteeing that information of the first blockchain is not leaked. The local consensus network cannot synchronize an upload result of the target transaction, and the object requesting to upload the target transaction cannot know whether the target transaction is really uploaded to the first blockchain by the target consensus network accordingly. Trust of the object in the real upload of the target transaction is affected.

### General Description of Some Embodiments

According to some embodiments, a method for processing a transaction of a blockchain is provided.

The method for processing a transaction of a blockchain may be applied to a service scenario where transaction data are not expected to be known to the outside, for example, the resource transfer transaction upload scenario shown in FIG. 2. The transaction that is not expected to be known to the outside is referred to as the target transaction. Some embodiments provides a solution that the target consensus network uniformly performs and records the target transactions, and transmits the transaction result data to the subscription node. The upload security of the target transaction can be improved, and the upload result interaction can be implemented. The method for processing a transaction of a blockchain is performed by the target consensus network, for example, the target consensus node in the target consensus network.

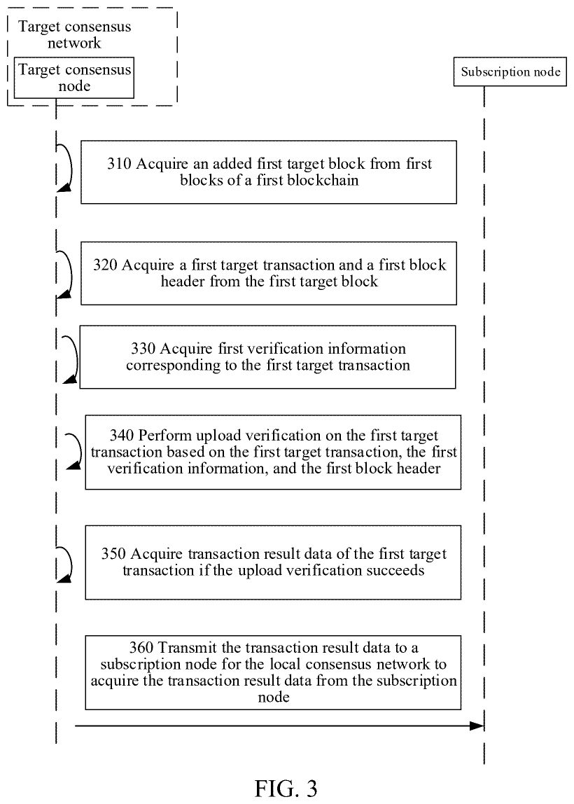

As shown in FIG. 3, the method for processing a transaction of a blockchain according to some embodiments may include the following operations:

Operation 310: Acquire an added first target block from first blocks of a first blockchain.

Operation 320: Acquire a first target transaction and a first block header from the first target block.

Operation 330: Acquire first verification information corresponding to the first target transaction.

Operation 340: Perform upload verification on the first target transaction based on the first target transaction, the first verification information, and the first block header.

Operation 350: Acquire transaction result data of the first target transaction if the upload verification succeeds.

Operation 360: Transmit the transaction result data to a subscription node for a local consensus network to acquire the transaction result data from the subscription node.

Operation 310 to operation 360 are described in detail below.

In operation 310, the first blockchain is composed of a plurality of first blocks, and the first blockchain forbids external access to the target consensus network, The first block is generated by the target consensus network, and is configured to record the first transaction of the target type from the local consensus network. The first transaction of the target type is the foregoing target transaction. Etime the target consensus network generates one first block based on the first transaction of the target type, and one first block is added to the first blockchain. The target consensus network acquires the first target block from the added first blocks. A process of acquiring the first target block will be described in detail below.

In operation 320, each first target block includes the first block header and the first block body, and a plurality of first transactions of the target type are stored in the first block body. The first block header may be acquired from the first target block, and the first target transaction may be acquired from the plurality of first transactions of the target type stored in the first block body.

In operation 330, the first verification information is configured for verifying information that the target consensus network really uploads the local transaction.

In some embodiments, setting of the acquisition period of the first verification information includes, but is not limited to, the following cases:

(1) the first verification information is immediately acquired after the target consensus network is found to acquire the first target transaction; and

(2) according to the acquisition period preset by the target consensus network, after the target consensus network is found to acquire the first target transaction and the acquisition period expires, the first verification information is acquired. For example, the acquisition period preset by the target consensus network is 1 hour. If the target consensus network is found to acquire the first target transaction at 7:00 a.m. that day, the first verification information is acquired at 8:00 a.m. that day.

An acquisition method of the first verification information will be introduced in the detailed description of operation 340 below together with operation 340.

In operation 340, the upload verification of the first target transaction is to verify whether the target consensus network really uploads the first target transaction. A process of the upload verification will be introduced in the detailed description of operation 340 below.

In operation 350, if the upload verification succeeds, the target consensus network really uploads the first target transaction, and the target consensus network acquires the transaction result data of the first target transaction. The transaction result data refer to data generated after the target consensus network executes the first target transaction. The transaction result data may indicate an upload success result. The upload success result indicates that the first target transaction is successfully uploaded. For example, the first target transaction is “the company A transfers 100 resources to the company B in May”, and corresponding transaction result data indicate “100 resources are transferred successfully”.

In operation 360, the transaction result data are transmitted to the subscription node. The subscription node is located between the local consensus network and the target consensus network and is a module configured to receive the transaction result data from the target consensus network and forward the transaction result data to the local consensus network. The subscription node may be an independent device, such as a separate computer or server. The subscription node may be part of an independent device, such as a virtual machine partitioned on the server.

In some embodiments, the local consensus network acquires the transaction result data from the subscription node by methods including but not limited to the following methods:

(1) After the subscription node receives the transaction result data, the subscription node may actively transmit the transaction result data to the local consensus network, such that the local consensus network acquires the transaction result data conveniently.

(2) The local consensus network transmits a transaction result data acquisition request to the subscription node, and the subscription node transmits the transaction result data to the local consensus network after receiving the transaction result data acquisition request.

Through operation 310 to operation 360, the target consensus network acquires the first target transaction, the first verification information corresponding to the first target transaction, and the first block header from the first target block added onto the first blockchain, and verifies whether the first target transaction is really uploaded accordingly. After the verification succeeds, the transaction result data are acquired and transmitted to the subscription node for query by the local consensus network. The local consensus network still acquires the transaction result data without reading the information of the target blockchain or reducing data security of the target blockchain, thus implementing the trusted upload result interaction while guaranteeing information security of the target blockchain.

Operation 310 to operation 360 are described above. The implementation of operation 310 to operation 360 will be described in detail below.

### Detailed Description of Operation 310

Operation 310: Acquire an added first target block from first blocks of a first blockchain.

For breakdown of operation 310, some embodiments provides two breakdown methods. The breakdown methods expand on operation 310 from different perspectives. A first breakdown method will be described at first.

In some embodiments, operation 310 includes: acquire the added first target block from the first blocks of the first blockchain in response to determining that a predetermined condition is satisfied.

The predetermined condition includes at least one of the following: a difference between a current block height of the first blockchain and a block height when the added first target block is acquired last time reaches a first threshold, and a time difference between a current time point and a time point of acquiring the added first target block last time reaches a second threshold. For example, in response to determining that the difference between the current block height of the first blockchain and the block height when the added first target block is acquired last time reaches the first threshold, the target consensus network acquires the added first target block from the first blocks of the first blockchain. For example, in response to determining that the time difference between the current time point and the time point of acquiring the added first target block last time reaches the second threshold, the target consensus network acquires the added first target block from the first blocks of the first blockchain. For example, in response to determining that the difference between the current block height of the first blockchain and the block height when the added first target block is acquired last time reaches the first threshold, and the time difference between the current time point and the time point of acquiring the added first target block last time reaches the second threshold, the target consensus network acquires the added first target block from the first blocks of the first blockchain.

Under the predetermined condition, if the difference of the block heights reaches the first threshold merely, acquisition timeliness is affected, resulting in a long-term failure of upload verification on some transactions. If the time difference reaches the second threshold merely, the timeliness is guaranteed, but too few first blocks may be included in the first target block each time, and network resources are wasted. If the difference of the block heights reaches the first threshold and the time difference reaches the second threshold, there is a possibility that the time difference reaches the second threshold but the difference of the block heights never reaches the first threshold, and the acquisition timeliness is still affected. The target consensus network always measures the height of the first blockchain, such that processing resources are wasted to a great extent, and improvement in processing efficiency is hindered.

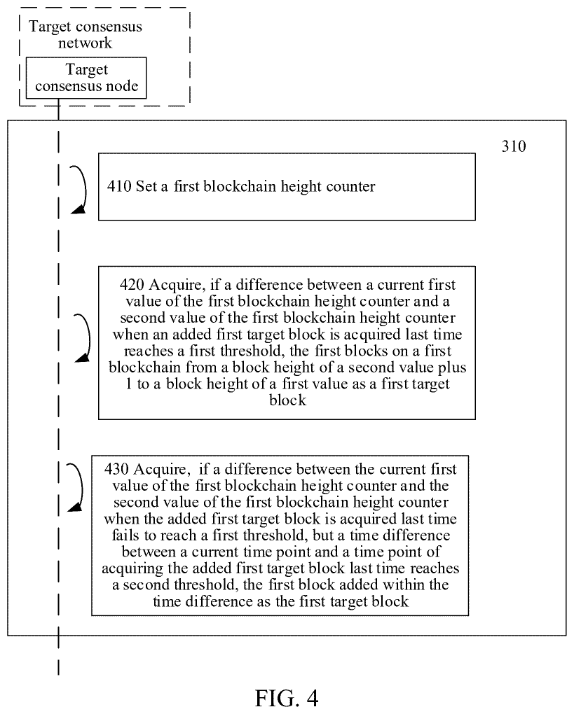

In some embodiments, with reference to FIG. 4, operation 310 includes:

Operation 410: Set the first blockchain height counter, the first blockchain height counter being increased by 1 when one first block is added to the first blockchain.

Operation 420: Acquire, if a difference between a current first value of the first blockchain height counter and a second value of the first blockchain height counter when the added first target block is acquired last time reaches a first threshold, the first blocks on the first blockchain from a block height of the second value plus 1 to a block height of the first value as the first target block.

Operation 430: Acquire, if a difference between the current first value of the first blockchain height counter and the second value of the first blockchain height counter when the added first target block is acquired last time fails to reach the first threshold, but a time difference between a current time point and a time point of acquiring the added first target block last time reaches a second threshold, the first block added within the time difference as the first target block.

Operation 410 to operation 430 are described in detail below.

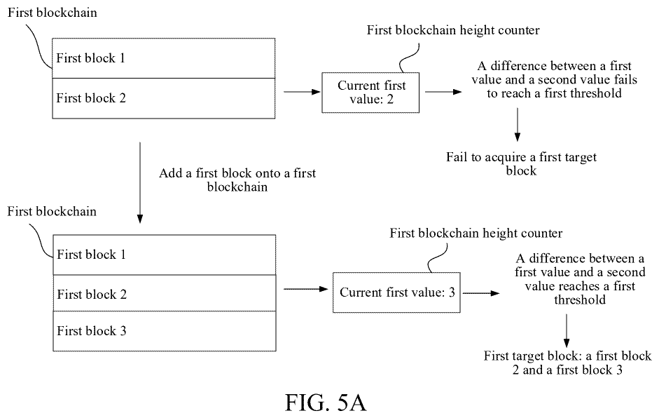

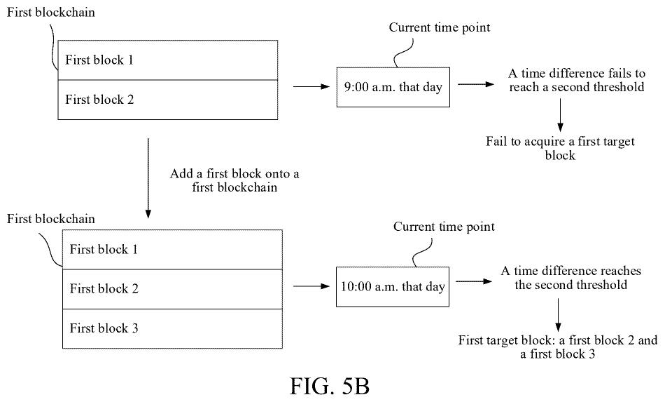

In operation 410, the first blockchain height counter refers to a module that counts the height of the first blockchain, The height of the first blockchain refers to a number of the first blocks, and the first blockchain height counter indicates the number of the first blocks with the first value. For example, with reference to FIG. 5A, the first blockchain includes a first block 1 and a first block 2. The number of the first blocks is 2, and the current first value of the first blockchain height counter is 2. After one first block is added to the first blockchain, the first blockchain further includes a first block 3, the number of the first blocks is 3, and the current first value of the first blockchain height counter is 3.

In operation 420, the first value refers to the current value of the first blockchain height counter, and the second value refers to the value when the added first target block is acquired last time. If the difference between the first value and the second value reaches the first threshold, the target consensus network may verify the upload of the first target transaction, and thus may acquire, as the first target block, the first blocks on the first blockchain from the block height of the second value plus 1 to the block height of the first value.

For example, with reference to FIG. 5A, the first threshold is assumed to be 2 and the second value is assumed to be 1 (the added first target block acquired last time is the first block 1). When the first blockchain includes the first block 1 and the first block 2, the first value is 2. The difference between the first value and the second value is 1 (2−1=1), and 1 is less than 2, and does not reach the first threshold, such that the first target block may not be acquired. After one first block is added to the first blockchain, the first value is 3. The difference between the first value and the second value is 2 (3−1=2), and 2 is equal to 2, and reaches the first threshold. The first block 2 and the first block 3 on the first blockchain may be acquired as the first target block. After the first block 3 is acquired, the second value is updated to 3.

Operation 430 is unlike operation 420 considering the first threshold. In operation 430, when the first threshold is not reached, influence of the time difference is considered, thus improving acquisition efficiency. On the premise that the first threshold is not reached, but the time difference between the current time point and the time point of acquiring the added first target block last time reaches the second threshold, the first block added within the time difference is acquired as the first target block.

For example, with reference to FIG. 5B, the first threshold is assumed to be 3, the second threshold is assumed to be 2 hours, the first value is assumed to be 1, and the time point of acquiring the added first target block last time is assumed to be 8:00 a.m. that day. When the first blockchain includes the first block 1 and the first block 2, the difference (2−1) between the first value and the second value does not reach the first threshold (3), and the time difference (9−8=1 hour) between the current time point (9:00 a.m. that day) and the time point of acquiring the added first block 1 last time does not reach the second threshold (2 hours), the first target block cannot be acquired.

With reference to FIG. 5B, after the first block is added to the first blockchain, the first blockchain further includes the first block 3. The difference (3−1) between the first value and the second value does not reach the first threshold (3), but the time difference (10−8=2 hours) between the current time point and the time point of acquiring the added first block 1 last time reaches the second threshold (2 hours), the first block 2 and the first block 3 on the first blockchain may be acquired as the first target block. After the first block 3 is acquired, the second value is updated to 3.

Some embodiments has the advantage that the height of the first blockchain is measured with the first blockchain height counter, and the processing resources of the target consensus network are saved. The difference between the first value and the second value and time difference are combined, such that the fact that too few first blocks are acquired each time and the processing resources are wasted is avoided. The timeliness is balanced, such that a long-term failure of upload verification on some first blocks is avoided.

When operation 310 includes operation 410 to operation 430, the first transaction is not considered though the block height and time difference are considered. For some first transactions that need priority upload verification, if the first block where the first transaction is located is not acquired from the first blockchain in time and the first block is not subject to upload verification, priority upload verification demand from different first transactions cannot be satisfied. In some embodiments, in operation 310, a priority setting flag of the first transaction is considered in combination. The first block of the first transaction at which the priority setting flag is set is acquired at first and is subject to upload verification, and the priority upload verification demand is satisfied.

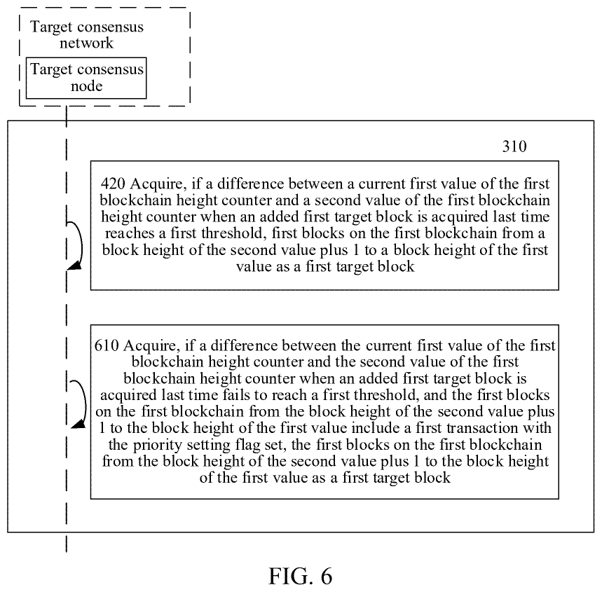

In implementation of some embodiments, the first transaction includes the priority setting flag. On this premise, with reference to FIG. 6, after operation 420, operation 310 further includes:

Operation 610: Acquire, if a difference between the current first value of the first blockchain height counter and the second value of the first blockchain height counter when the added first target block is acquired last time does not reach the first threshold, and the first blocks on the first blockchain from the block height of the second value plus 1 to the block height of the first value include the first transaction with the priority setting flag set, the first blocks on the first blockchain from a block height of the second value plus 1 to a block height of the first value as the first target block.

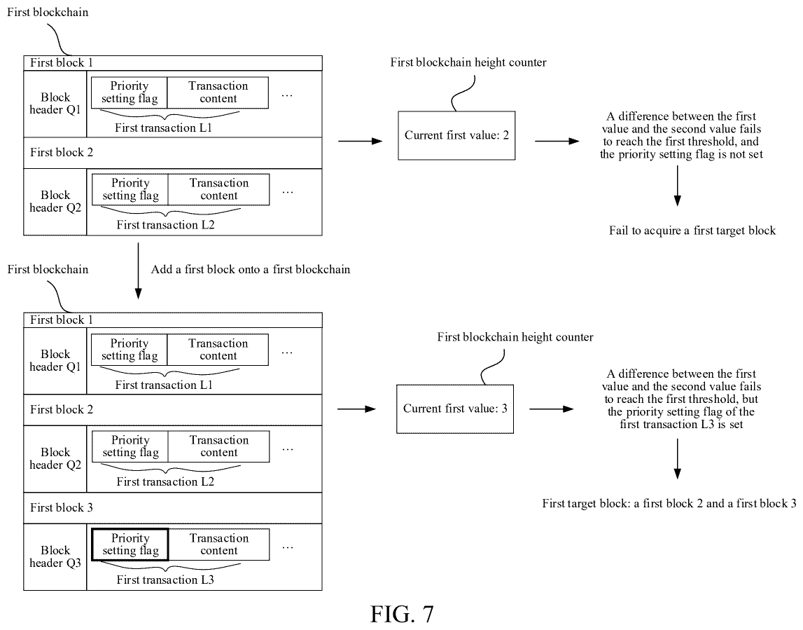

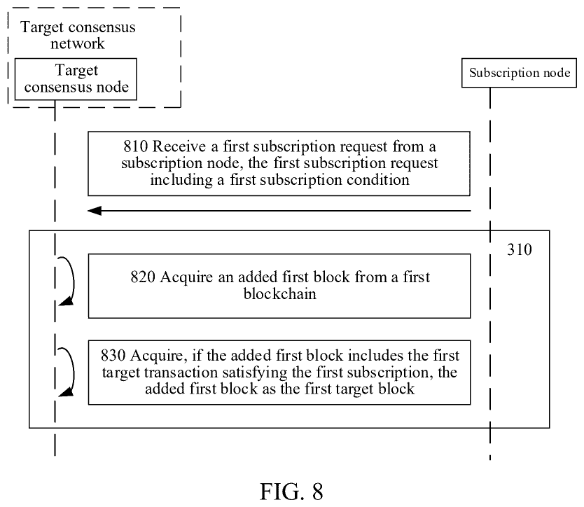

For example, with reference to FIG. 7, the first threshold is assumed to be 3 and the second value is assumed to be 1 (the added first target block acquired last time is the first block 1). When the first blockchain includes the first block 1 and the first block 2, the first block 1 includes a first block header Q1 and a first transaction L1. The first transaction L1 includes a priority setting flag and a transaction content, but the priority setting flag of the first transaction L1 is not set (for example, the priority setting flag is 0). The first block 2 includes a first block header Q2 and a first transaction L2. The first transaction L2 includes a priority setting flag and a transaction content, but the priority setting flag of the first transaction L2 is not set (for example, the priority setting flag is also 0). When the first blockchain includes the first block 1 and the first block 2, the difference (2−1) between the first value and the second value does not reach the first threshold (3), and the priority setting flag is not set, the first target block cannot be acquired.

With reference to FIG. 7, after another first block is added to the first blockchain, the first blockchain further includes the first block 3, the first block 3 includes a first block header Q3 and a first transaction L3, and the first transaction L3 includes a priority setting flag and a transaction content, but the priority setting flag of the first transaction L3 is set (for example, the priority setting flag is 1 and denoted with a bold black box in FIG. 7). The difference (3−1) between the first value and the second value does not reach the first threshold (3), but the priority setting flag of the first transaction L3 is set, such that the first block 2 and the first block 3 on the first blockchain are acquired as the first target block. After the first block 3 is acquired, the second value is updated to 3.

Some embodiments has the advantage that the priority upload verification demand from the first transaction is satisfied with the priority setting flag, and flexibility of the upload verification may be improved.

The first breakdown method is described in detail above, and the second breakdown method is described in detail below.

In some embodiments, before operation 310, the method for processing a transaction of a blockchain further includes the following operations:

Operation 810: Receive a first subscription request from the subscription node, the first subscription request including the first subscription condition.

Correspondingly, operation 310 includes:

Operation 820: Acquire the added first block from the first blockchain.

Operation 830: Acquire the added first block as the first target block if the added first block includes the first target transaction satisfying the first subscription condition.

Operation 810 to operation 830 are described in detail below.

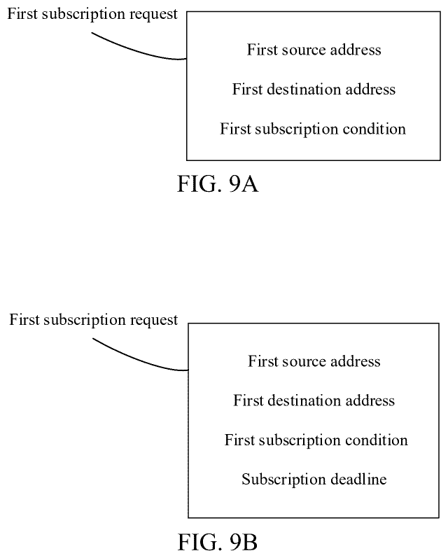

In operation 810, the first subscription request refers to a request for subscribing to the first transaction transmitted by the subscription node to the target consensus network. With reference to FIG. 9A, the first subscription request includes a first source address, a first destination address, and a first subscription condition. The first source address refers to an address of the subscription node (for example, an identifier of the subscription node). The first destination address refers to an address of the global consensus node in the target consensus network (for example, an identifier of the global consensus node). The first subscription condition refers to a personalized subscription condition of the subscription node for the first transaction recorded on the first blockchain. The added first block includes the first target transaction satisfying the first subscription condition. The first block may be acquired for the upload verification, and the first block is regarded as the first target block.

Some embodiments of operation 820 is similar to the implementation process of operation 410 to operation 430 described abovein for saving space.

In operation 830, if the added first block includes the first target transaction satisfying the first subscription condition, the first block includes the transaction needs the upload verification, such that the added first block is acquired as the first target block. The upload verification can be performed in time, such that the subscription node can be informed of the transaction result data of the first target transaction in time after the upload verification succeeds.

Some embodiments has the advantage that by regarding the first block that includes the first target transaction satisfying the first subscription condition as the first target block, the number of the first blocks subject to upload verification can be reduced, and processing resources can be saved. By determining the first subscription condition from the first subscription request transmitted by the subscription node, personalized subscription demand from the subscription node for the transaction requiring the upload verification can be satisfied.

With reference to FIG. 9B, the first subscription request shown in FIG. 9B has a subscription deadline besides the source address, the destination address, and the first subscription condition. In a case that the first subscription request also has the subscription deadline, operation 830 includes:

determine a valid subscription request whose subscription deadline does not expire from the first subscription request; and

acquire the added first block as the first target block if the added first block includes the first target transaction satisfying the first subscription condition of the valid subscription request.

The subscription deadline refers to a deadline of the first subscription request from validity to invalidity. If the subscription deadline does not expire, the first subscription request is a valid subscription request. If the subscription deadline expires, the first subscription request is an invalid subscription request. For example, if the subscription deadline is February 1 of that year, the first subscription request is the valid subscription request before February 1 of that year from reception of the first subscription request by the target consensus network. If the added first block includes the first target transaction satisfying the first subscription condition of the valid subscription request, the first block includes the transaction requiring the upload verification and the transaction satisfies the first subscription condition, such that the added first block is acquired as the first target block.

Some embodiments has the advantage that with the subscription deadline, the first transaction that fails to satisfy the first condition can be prevented from being subject to the upload verification, and the processing resources are saved. By determining the subscription deadline from the first subscription request transmitted by the subscription node, the personalized subscription demand from the subscription node for the transaction requiring the upload verification can be further satisfied.

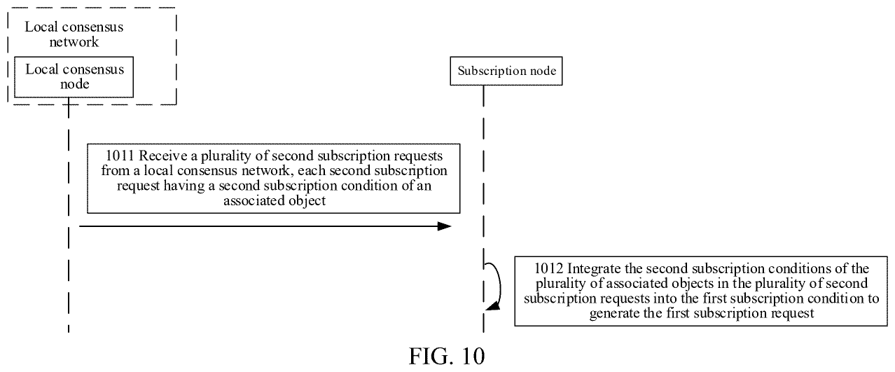

With reference to FIG. 10, in some embodiments, the first subscription request is generated by the subscription node by the following method:

Operation 1011: Receive a plurality of second subscription requests from the local consensus network, each second subscription request having a second subscription condition of an associated object.

Operation 1012: Integrate the second subscription conditions of the plurality of associated objects in the plurality of second subscription requests into the first subscription condition to generate the first subscription request.

Operation 1011 to operation 1012 are described in detail below.

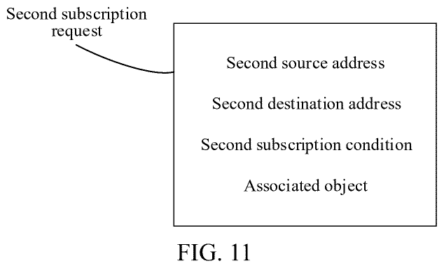

In operation 1011, the second subscription request refers to a request for subscribing to the first transaction transmitted by the local consensus network to the subscription node. For example, with reference to FIG. 11, the second subscription request includes a second source address, a second destination address, a second subscription condition, and an associated object. The second source address refers to an address of the local consensus node in the local consensus network, for example, an identifier of the local consensus node. The second destination address refers to an address of the subscription node, for example, an identifier of the subscription node. The second subscription condition refers to a personalized subscription condition of the associated object for the first transaction recorded on the first blockchain. The associated object refers to an object corresponding to the second subscription condition. For example, the associated object is the service node in FIG. 1.

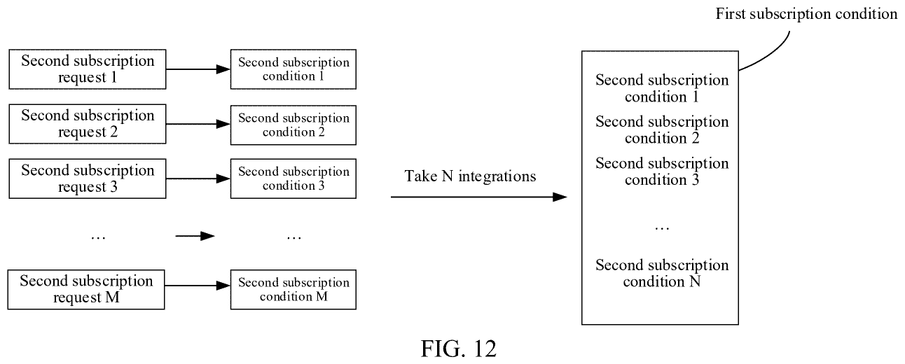

In operation 1012, the subscription node integrates the second subscription conditions of the plurality of associated objects into the first subscription condition. For example, with reference to FIG. 12, the subscription node receives the second subscription conditions 1 to M. From the second subscription conditions 1 to M, the second subscription conditions 1 to M can be acquired, and N (N is less than or equal to M) second subscription conditions are integrated to acquire the first subscription condition. The first subscription condition includes the second subscription conditions 1 to N. When N is less than M, the subscription node may integrate the second subscription conditions of N+1 to M to acquire a new first subscription condition. The first subscription condition includes the second subscription conditions N+1 to M.

Some embodiments has the advantage that the first subscription condition is acquired by integrating the plurality of second subscription conditions and transmitted to the target consensus network. The subscription node transmits the plurality of second subscription conditions to the target consensus network equivalently. Compared with a method that one subscription node transmits one second subscription condition etime merely, the number of second subscription conditions is increased, and network resources are saved. The target consensus network can process the plurality of second subscription conditions in batches, and the processing efficiency may be improved.

The two breakdown methods of operation 310 are described in detail above. The two breakdown methods are based on the fact that the blockchain hierarchical consensus network includes one subscription node. After operation 310 to operation 350, the target consensus network acquires the transaction result data, and in operation 360, all the transaction result data are transmitted to the same subscription node. In some embodiments, the subscription nodes are the plurality of subscription nodes corresponding to a plurality of transaction subtypes, and transaction result data of different transaction subtypes may be transmitted to corresponding subscription nodes. For example, one subscription node is responsible for collecting transaction result data of transactions of an electronic invoice subtype, and another subscription node is responsible for collecting transaction result data of transactions of a resource subtype.

In the implementation of some embodiments, the subscription nodes are the plurality of subscription nodes corresponding to the plurality of transaction subtypes, and the first subscription condition is the transaction subtype corresponding to the subscription node. Correspondingly, operation 360 includes: transmit the transaction result data to the subscription node corresponding to the transaction subtype.

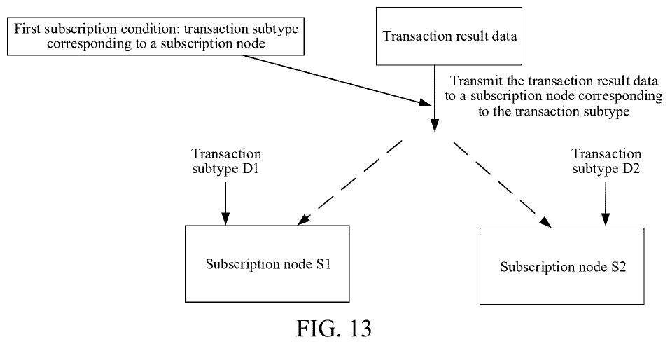

For example, with reference to FIG. 13, FIG. 13 shows two subscription nodes, for example, a subscription node 1 and a subscription node 2. The subscription node 1 corresponds to a transaction subtype D1, for example, the transaction subtype D1 is the electronic invoice subtype. The subscription node 2 corresponds to the transaction subtype D2, for example, the transaction subtype D2 is the resource subtype. FIG. 13 further shows transaction result data. Before the transaction result data may be transmitted to the subscription node, the transaction subtype corresponding to the subscription node is known through the first subscription condition, and the transaction result data are transmitted to the subscription node corresponding to the transaction subtype. For example, the transaction subtype is the electronic invoice subtype as known from the first subscription condition, and the transaction result data are transmitted to the subscription node 1. For example, the transaction subtype is the resource subtype as known from the first subscription condition, and the transaction result data are transmitted to the subscription node 2.

Some embodiments has the advantage that the transaction result data of the same transaction subtype are effectively transmitted to the same subscription node through a correspondence relation between the transaction subtype and the subscription node. The personalized subscription demand from the subscription node for the target consensus network based on the first subscription condition is fully satisfied. The possibility of transmitting the transaction result data to other subscription nodes that do not satisfy the correspondence relation with the transaction subtype is reduced, data leakage is reduced, and security is further improved.

In some embodiments, a plurality of subscription nodes are also provided. Different from the above embodiment, the subscription nodes of some embodiments are the plurality of subscription nodes corresponding to a plurality of object sets. For example, one subscription node is responsible for collecting transaction result data of associated objects C1-C10, and another subscription node is responsible for collecting transaction result data of associated objects C11-C20.

In the implementation of some embodiments, the first transaction in the first block includes an identifier of the associated object, and the subscription nodes are the plurality of subscription nodes corresponding to the plurality of object sets. The first subscription condition is that the identifier of the associated object of the first transaction belongs to the object set corresponding to the subscription node. Correspondingly, operation 360 includes: transmit the transaction result data to the subscription node corresponding to the object set to which the identifier of the associated object belongs.

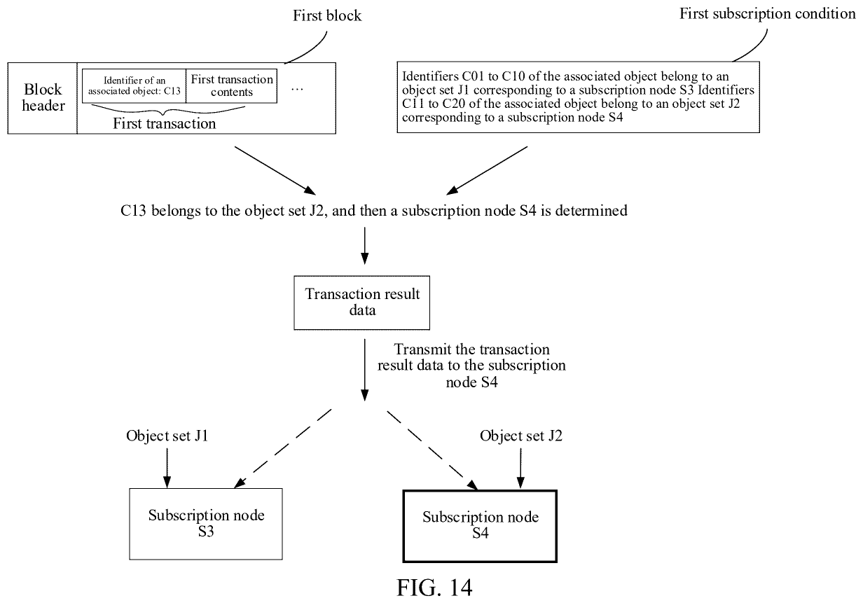

For example, with reference to FIG. 14, the first block shown in FIG. 14 has a block header and a first transaction, and the first transaction includes the identifier of the associated object and a content of the first transaction. The identifier of the associated object of the first transaction is C13. The content of the first transaction is “the company A transfers 100 resources to the company B in May”, and corresponding transaction result data indicate “100 resources are transferred successfully”. The first subscription condition shown in FIG. 14 includes as follows: “identifiers C01 to C10 of the associated object belong to an object set J1 corresponding to a subscription node 3” and “identifiers C11 to C20 of the associated object belong to an object set J2 corresponding to a subscription node 4”. The two subscription nodes shown in FIG. 14 are the subscription node 3 and the subscription node 4 respectively. The subscription node 3 corresponds to the object set J1, and the subscription node 4 corresponds to the object set J2.

With reference to FIG. 14, before the transaction result data may be transmitted to the subscription node, the identifier of the associated object is known as C13 through the first block, and C13 is known to belong to the object set J2 through the first subscription condition, such that the subscription node 4 is determined. The transaction result data (the transaction result data indicate “100 resources are transferred successfully”) are transmitted to the subscription node 4 (at a bold black box shown in FIG. 14). In another example, if the identifier of the associated object is C03, the object set J1 is determined according to C03, and the subscription node 3 is further determined. The transaction result data (the transaction result data indicates “100 resources are transferred successfully”) may be transmitted to the subscription node 3.

Operation 310 is described in detail above.

### Detailed Description of Operation 320

Operation 310 is broken down into operation 810 to operation 830. Operation 830: Acquire the added first block as the first target block in a case that the first block includes the first target transaction satisfying the first subscription condition. Correspondingly, after operation 310, operation 320 includes: acquire a first transaction satisfying the first subscription condition from the plurality of first transactions in the first target block as the first target transaction.

Not all the plurality of first transactions in the first target block may be acquired, and the number of the first transactions acquired is reduced. The processing efficiency can be further improved by screening the plurality of first transactions again with the first subscription condition.

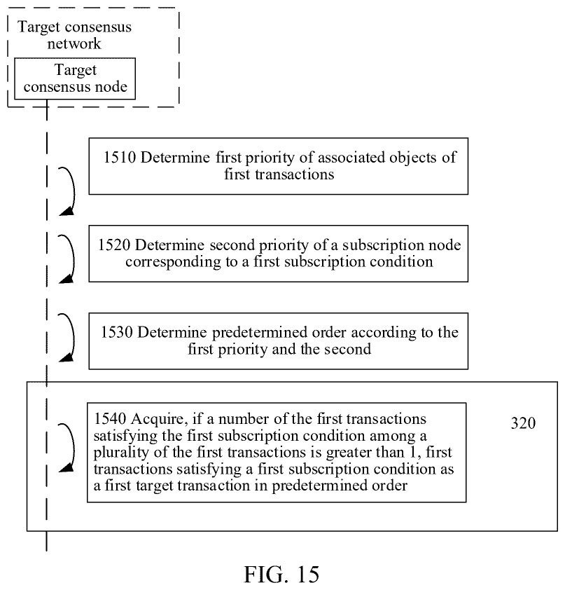

With reference to FIG. 15, in some embodiments, operation 320 includes:

Operation 1540: Acquire, if a number of first transactions satisfying the first subscription condition among a plurality of the first transactions is greater than 1, the first transactions satisfying the first subscription condition as the first target transaction in predetermined order,

the predetermined order being determined by the following method:

Operation 1510: Determine first priority of associated objects of the first transactions.

Operation 1520: Determine second priority of the subscription node corresponding to the first subscription condition.

Operation 1530: Determine the predetermined order according to the first priority and the second priority.

Operation 1510 to operation 1540 are described in detail below.

In operation 1510, determination methods for the first priority include but are not limited to the following:

(1) a first tag of the associated object is acquired from the first transaction, and a comparison table of the first tag and the first priority is searched according to the first tag to determine the first priority. The comparison table of the first tag and the first priority lists a correspondence relation between the first tag and the first priority. An example of the comparison table of the first tag and the first priority is provided below:

TABLE 1

| First tag | First priority |
|---|---|
| High importance | 5 |
| Average importance | 3 |
| Unimportance | 1 |

As shown in Table 1, if the first tag indicates high importance, the associated object is an object of high importance, such that the first priority is set as 5. According to different degrees of importance of the associated objects, the first priority corresponding to the first tag of average importance is set as 3, and the first priority corresponding to the first tag of unimportance is set as 1.

(2) The identifier of the associated object is acquired from the first transaction, an identifier range is determined according to the identifier of the associated object, and a comparison table of the identifier range and the first priority is searched according to the identifier range to determine the first priority. The comparison table of the identifier range and the first priority lists a correspondence relation between the identifier range and the first priority. An example of the comparison table of the identifier range and the first priority is provided below:

TABLE 2

| Identifier range | First priority |
|---|---|
| C01-C10 | 3 |
| C11-C20 | 2 |
| C21-C30 | 1 |

As shown in Table 2, for the identifier range from an identifier C01 to an identifier C10 of the associated object, the associated object within the identifier range may be an object of high importance. The first transaction is to be acquired immediately, such that the first priority is set as 3. According to different degrees of importance of the associated objects, the first priority corresponding to the identifier range from C11 to C20 is set as 2, and the first priority corresponding to the identifier range from C21 to C30 is set as 1.

In operation 1520, determination methods for the second priority include but are not limited to the following:

(1) the second priority is acquired from the content of the first subscription condition. For example, the content of the first subscription condition includes “the second priority of the subscription node 4 is 3”, the second priority is 3 as can be known from the first subscription condition.

(2) a second tag of the subscription node is acquired, and a comparison table of the second tag and the second priority is searched according to the second tag to determine the second priority. The comparison table of the second tag and the second priority lists a correspondence relation between the second tag and the second priority. An example of the comparison table of the second tag and the second priority is provided below:

TABLE 3

| Second tag | Second priority |
|---|---|
| High importance | 6 |
| Average importance | 4 |
| Unimportance | 2 |

As shown in Table 3, if the second tag indicates high importance, the subscription node is a node of high importance, such that the second priority is set as 6. According to different degrees of importance of the subscription nodes, the second priority corresponding to the second tag of average importance is set as 4, and the second priority corresponding to the second tag of unimportance is set as 2.

After operation 1510 and operation 1520, the target consensus network acquires the first priority and the second priority. In operation 1530, the target consensus network determines predetermined order according to the first priority and the second priority. In operation 1540, the target consensus network acquires the first transaction satisfying the first subscription condition from the plurality of first transactions as the first target transaction in predetermined order.

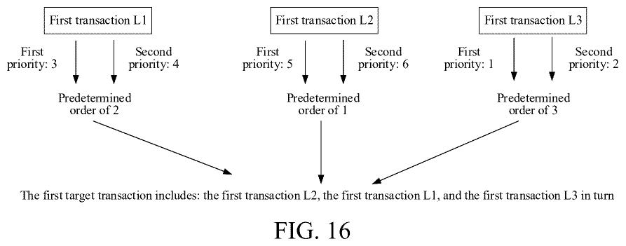

For example, with reference to FIG. 16, the target consensus network acquires three first transactions from the first target block, for example, a first transaction L1, a first transaction L2, and a first transaction L3. The first priority and the second priority of the first transaction L1 are 3 and 4 respectively. The first priority and the second priority of the first transaction L2 are 5 and 6 respectively. The first priority and the second priority of the first transaction L3 are 1 and 2 respectively. According to the first priority and the second priority, it is determined that the predetermined order of the first transaction L1 is 2, the predetermined order of the first transaction L2 is 1, and the predetermined order of the first transaction L3 is 3. The first target transaction includes the first transaction L2, the first transaction L1, and the first transaction L3 in turn.

Some embodiments has the advantage that the priority upload verification demand from different first transactions are satisfied according to the associated object and the subscription node, and the upload verification flexibility may be improved, thus improving the upload verification flexibility of the first transaction.

Operation 1510 to operation 1540 are described above. Operation 1530 is described in detail below.

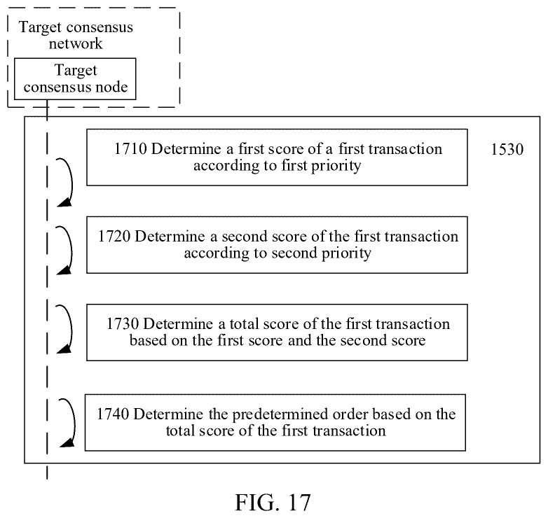

With reference to FIG. 17, operation 1530 includes:

Operation 1710: Determine a first score of the first transaction according to the first priority.

Operation 1720: Determine a second score of the first transaction according to the second priority.

Operation 1730: Determine a total score of the first transaction based on the first score and the second score.

Operation 1740: Determine the predetermined order based on the total score of the first transaction.

Operation 1710 to operation 1740 are described in detail below.

In operation 1710, based on the first priority, the first score is determined by searching a comparison table of the first priority and the first score, or by using a formula method.

(1) According to the first priority, the comparison table of the first priority and the first score (the comparison table of the first priority and the first score lists a correspondence relation between the first priority and the first score) is searched to acquire the first score. An example of the comparison table of the first priority and the first score is provided below:

TABLE 4

| First priority | First score |
|---|---|
| 4 or higher | 100 |
| 3 | 90 |
| 2 | 80 |
| 1 | 70 |

For example, the first priority of the first transaction L1 is 3, and a corresponding first score is 60 by searching Table 4.

The method for searching the comparison table of the first priority and the first score has the advantages of simplicity, convenience, and low processing cost.

(2) When the formula method is used, the first score and the first priority may be set in direct proportional, for example:

$$F 1 = K 1 \cdot G 1 \qquad Formula 1$$

In the formula, F1 denotes the first score, G1 denotes the first priority, and K1 is a preset constant, and may be set according to actual demand. For example, K1=20, and after G1=3 is substituted, the first score F1=60.

The method of determining the first score by the formula has the advantages that accuracy is high, the formula can be adjusted according to demand, and high flexibility is achieved.

In operation 1720, based on the second priority, the second score is determined by searching a comparison table of the second priority and the second score, or by using a formula method.

(1) According to the second priority, the comparison table of the second priority and the second score (the comparison table of the second priority and the second score lists a correspondence relation between the second priority and the second score) is searched to acquire the second score. An example of the comparison table of the second priority and the first score is provided below:

TABLE 5

| Second priority | Second score |
|---|---|
| 6 or higher | 100 |
| 5 | 90 |
| 4 | 80 |
| 3 | 70 |
| 1-2 | 60 |

For example, the second priority of the first transaction L1 is 4, and a corresponding second score is 80 by searching Table 5.

The method for searching the comparison table of the second priority and the second score has the advantages of simplicity, convenience, and low processing cost.

(2) When the formula method is used, the second score and the second priority may be set in direct proportional, for example:

$$F 2 = K 2 \cdot G 2 \qquad Formula 2$$

In the formula, F2 denotes the second score, G2 denotes the first priority, and K2 is a preset constant, and may be set according to actual demand. For example, K2=20, and after G2=4 is substituted, the second score F2=80.

The method of determining the second score by the formula has the advantages that accuracy is high, the formula can be adjusted according to demand, and high flexibility is achieved.

In operation 1730, based on the first score and the second score, the total score of the first transaction is determined, and an average or a weighted average of the first score and the second score may be computed.

The average of the first score and the second score is computed as the total score. For example, the first score of the first transaction L1 is 60, the second score is 80, and the total score is (60+80)/2=70. By using the average to compute the total score of the first transaction, influence of the first priority and influence of the second priority on the order of the first transaction among the plurality of first transactions can be equally reflected.

The weighted average of the first score and the second score is computed as the total score. For example, weights for the transaction priority and the difference are set as 0.6 and 0.4 respectively, the first score of the first transaction L1 is 60, the second score is 80, and the total score is 60×0.6+80×0.4=68. By using the weighted average to compute the total score, different weights can be set for the first priority and the second priority, and flexibility of determination of the order of the first transaction among the plurality of first transactions may be improved.

In operation 1740, the predetermined order is determined based on the total score of the first transaction. In some embodiments, determination methods of the order include the following:

(1) According to the total score, a comparison table (the comparison table of the total score and the predetermined order lists a correspondence relation between the total score and the predetermined order) of the total score and the predetermined order is searched, and the predetermined order may acquired. An example of the comparison table of the total score and the predetermined order is provided below:

TABLE 6

| Total score range | Predetermined order |
|---|---|
| 90 points or higher | 1 |
| 80-89 points | 2 |
| 70-79 points | 3 |
| 60-69 points | 4 |
| 50-59 points | 5 |
| . . . | . . . |

The total score of the first transaction L1 is assumed to be 70, and Table 6 is searched for corresponding predetermined order of 3.

The method for searching the comparison table of the total score and the order has the advantages of simplicity, convenience, and low processing cost.

(2) When the formula method is used, the predetermined order and the total score may be set in inversely proportional, for example:

$$D = K 3 \cdot F 3 + K 4 \qquad Formula 3$$

In the formula, D denotes the order, F3 denotes the total score, and K3 and K4 are preset constants, and may be set according to actual demand. For example, K3=−2/70, K4=5, and after F3=70 is substituted, D=3.

The method of determining the order by the formula has the advantages that accuracy is high, the formula can be adjusted according to demand, and high flexibility is achieved.

From Operation 1710 to operation 1740, some embodiments of determining the predetermined order according to the first priority and the second priority has the advantage as follows: by effectively evaluating a degree of demand from the first transaction for priority processing, the first transaction with a high demand level is given priority as the first target transaction, such that the target consensus network can give priority to processing of the first target transaction, and the flexibility of processing the first target transaction can be improved.

Operation 320 is described in detail above.

### Detailed Description of Operation 340

Operation 340: Perform upload verification on the first target transaction based on the first target transaction, the first verification information, and the first block header.

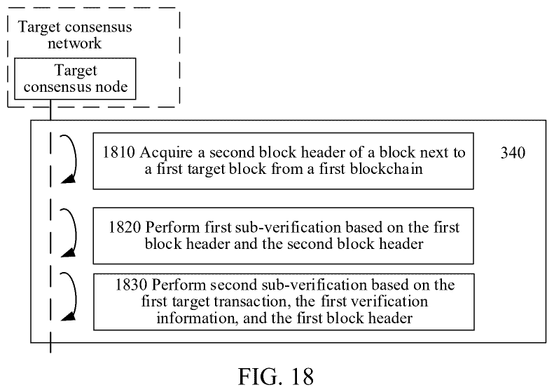

With reference to FIG. 18, in some embodiments, the upload verification includes first sub-verification and second sub-verification, and operation 340 includes:

Operation 1810: Acquire the second block header of a block next to the first target block from the first blockchain.

Operation 1820: Perform the first sub-verification based on the first block header and the second block header of the next block.

Operation 1830: Perform the second sub-verification based on the first target transaction, the first verification information, and the first block header.

Operation 1810 to operation 1830 are described in detail below.

In operation 1810, between the plurality of blocks on the first blockchain, the latter block header is related to the previous block header. To perform the first sub-verification in operation 1820, the block header of the block next to the first target block may be acquired as the second block header.

In operation 1820, the first sub-verification refers to security verification of the first target block where the first target transaction is located. The first blockchain is composed of the plurality of first blocks, and in the block header of a genesis block in the plurality of first blocks, digest values of first block bodies are stored instead of digest values of second block bodies. In the plurality of first blocks, except for the block header in the genesis block, other block headers include the digest values of the first block bodies and the digest values of the second block bodies. For the same first block, the digest value of the first block body refers to a feature value of the first block, while the digest value of the second block body refers to a feature value of a block (also known as a parent block) previous to the first block. For two adjacent first blocks, if the digest value of the first block body of a latter block is equal to the digest value of the second block body of the previous block, the two first blocks are indeed associated, and the first sub-verification passes. If the digest value of the first block body of the latter block is not equal to the digest value of the second block body of the previous block, tempering with a particular first block occurs, and the first sub-verification fails.

In some embodiments, the block header of the first block includes the digest value of the first block body of the first block and the digest value of the second block body of the block previous to the first block on the first blockchain. During implementation of some embodiments, operation 1820 includes:

determine that the first sub-verification succeeds if the digest value of the first block body in the first block header is equal to the digest value of the second block in the second block header.

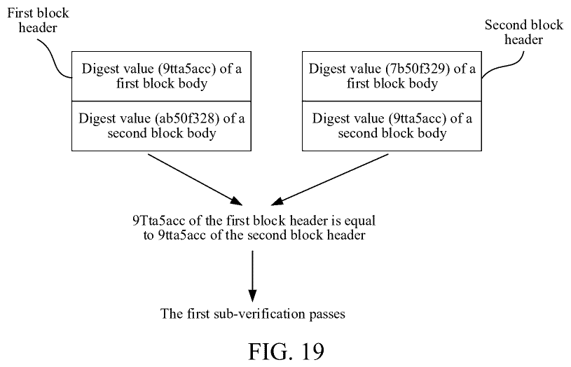

For example, with reference to FIG. 19, the first block header and the second block header are shown in FIG. 19. The digest value of the first block body in the first block header is 9tta5acc, and the digest value of the second block body is ab50f328. The digest value of the first block body in the second block header is 7b50f329, and the digest value of the second block body is 9tta5acc. The digest value (9tta5acc) of the first block header in the first block header is equal to the digest value (9tta5acc) of the second block body in the second block header, the first block header and the second block header are indeed associated, and the first sub-verification passes.

In operation 1830, the second sub-verification refers to security verification of the first target transaction. A process of the second sub-verification will be detailed below.

Some embodiments has the advantage that through the first sub-verification and the second sub-verification, the security verification of the first target block where the first target transaction is located is performed, and the security verification of the first target transaction is further performed, thus greatly improving verification credibility.

Operation 1810 to operation 1830 are described above. Operation 1830 is described in detail below.

The second sub-verification in operation 1830 may be based on the first verification information acquired in operation 330. Operation 1830 will be further described in detail in conjunction with operation 330.

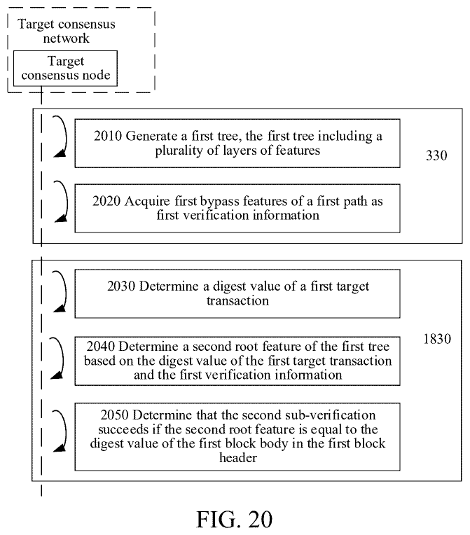

With reference to FIG. 20, in some embodiments, operation 330 includes:

Operation 2010: Generate a first tree, the first tree including a plurality of layers of features.

Operation 2020: Acquire first bypass features of a first path as the first verification information.

Correspondingly, operation 1830 includes:

Operation 2030: Determine a digest value of the first target transaction.

Operation 2040: Determine a second root feature of the first tree based on the digest value of the first target transaction and the first verification information.

Operation 2050: Determine that the second sub-verification succeeds if the second root feature is equal to the digest value of the first block body in the first block header.

Operation 2010 to operation 2050 are described in detail below.

In operation 2010, a lowest layer of features of the first tree are digest values of a plurality of first transactions in the first target block, and the plurality of first transactions include the first target transaction.

Order of the lowest layer of features of the first tree may be the order in which the target consensus node receives the first transactions. For example, the target consensus node receives a first transaction L1 “the company A transfers 100 resources to the company B in May” at and then receives a first transaction L2 “the company A transfers 200 resources to the company C in May”. The first transaction L1 is regarded as the first node of the lowest layer of nodes and the first transaction L2 is regarded as the second node of the lowest layer of nodes. A digest algorithm used by the digest value may be one of the following:

(1) A fixed digest algorithm that is the same for entities to which the first transactions belong and is pre-specified by the target consensus node. For example, the same digest algorithm is used for the resource transfer transaction between the company A and the company B and the resource transfer transaction between the company A and the company C.

(2) Different digest algorithms pre-specified by the target consensus node for entities to which the first transactions belong. For example, different digest algorithms are pre-specified for the company B and company C. When it is determined that the first transaction is the transaction between the company A and the company B, the digest algorithm pre-specified for the company B is used. When it is determined that the first transaction is the transaction between the company A and the company C, the digest algorithm pre-specified for the company C is used. In some embodiments, different digest algorithms are used for different entities, difficulty of cracking local transactions based on digest values is increased, and security of the upload verification of the first transaction may be improved.

No matter which digest algorithm is used, the digest algorithms used by the target consensus node for verification according to the digest value of the first transaction and the first bypass feature may be guaranteed consistent with the digest algorithm.

In some embodiments, two adjacent features of each layer of the first tree are connected to and generate a feature of an upper layer until the first root feature of the first tree is generated, and the first root feature is the digest value of the first block body.

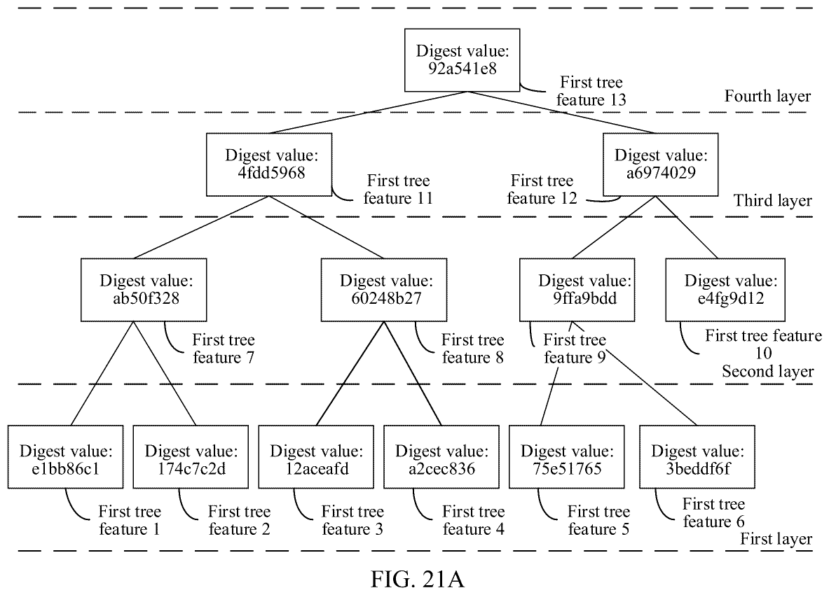

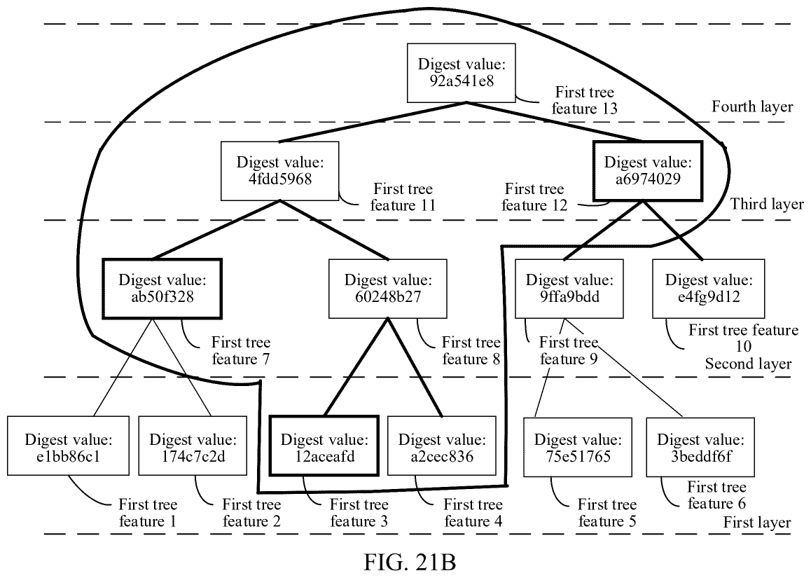

The first tree in some embodiments may be a binary tree or a multi-ary tree. The first tree has all features of a tree structure, and the tree structure often includes a plurality of nodes (the first tree feature shown in FIG. 21A). The plurality of nodes include at least one leaf node and one root node and usually further includes a plurality of intermediate nodes between the leaf node and the root node.

A generation process of the first tree is as follows:

with reference to the first tree shown in FIG. 21A, feature data of each first tree feature are regarded as one feature of the first tree. The first tree includes a plurality of layers of features, each lowest layer of features of the first tree corresponds to the first transaction recorded on the single first blockchain, and each lowest layer of features is the feature of the first transaction recorded (as shown in FIG. 21A, the feature of the first transaction is the digest value). Two adjacent features of each layer of the first tree are connected to generate the upper layer of features. Each feature in the upper layer is acquired by an operation of two adjacent features of a lower layer (as shown in FIG. 21A, the digest value in the feature in the upper layer may be acquired through the digest operation on digest values in the two adjacent features of the lower layer). By analogy, the root feature of the first tree is generated, and a complete first tree is acquired. As shown in FIG. 21A, the first tree feature 1 and the second tree feature 2 of the lowest layer are connected in series to generate the first tree feature 7 of a penultimate layer through the digest algorithm. The first tree feature 3 and the second tree feature 4 of the lowest layer are connected in series to generate the first tree feature 8 of the penultimate layer through the digest algorithm. The first tree feature 5 and the second tree feature of the lowest layer are connected in series to generate the first tree feature 9 of the penultimate layer through the digest algorithm. The first tree feature 7 and the second tree feature 8 of the penultimate layer are connected in series to generate the first tree feature 11 of an antepenultimate layer through the digest algorithm. The first tree feature 9 and the second tree feature 10 of the penultimate layer are connected in series to generate the first tree feature 12 of the antepenultimate layer through the digest algorithm. The first tree feature 11 and the second tree feature 12 of the antepenultimate layer are connected in series to generate, through the digest algorithm, the first tree feature 13, for example, the first root feature.

In operation 2020, the first path is a path between a digest value of the first target transaction on the first tree and the first root feature, and the first bypass features are lower layers of features to which other features on the first path except the digest value of the first target transaction are connected.

As shown in FIG. 21B, by assuming that the feature of the digest value of the first target transaction corresponds to the first tree feature 4, and the first root feature of the first tree corresponds to the first tree feature 13, the first path is the path from the first tree feature 4 to the first tree feature 13 on the first tree. The first path covers connection paths between the first tree feature 4, the first tree feature 8, the first tree feature 11, and the first tree feature 13. Since the first tree feature 8 may be generated based on the first tree feature 3 and the first tree feature 4, the feature of the first tree feature 3 may be further acquired in a case that the feature of the first tree feature 4 is known. It is determined that the feature of the first tree feature 3 is the bypass feature. Since the first tree feature 11 may be generated based on the first tree feature 7 and the first tree feature 8, the feature of the first tree feature 7 may be further acquired after the first tree feature 8 is generated based on the first tree feature 3 and the first tree feature 4 as the bypass feature. It is determined that the feature of the first tree feature 7 is the bypass feature. Since the first tree feature 13 may be generated based on the first tree feature 11 and the first tree feature 12, the feature of the first tree feature 12 may be further acquired after the first tree feature 11 is generated based on the first tree feature 8 and the first tree feature 7 as the bypass feature. It is determined that the feature of the first tree feature 12 is the bypass feature. The first bypass features of the first path include the features of the first tree feature 3, the first tree feature 7, and the first tree feature 12, and the first bypass features are denoted with thick black boxes in FIG. 21B. Other features in the first tree except the first bypass features and the lowest layer of features corresponding to the first target transaction are not provided for the target consensus node.

Operation 2010 to operation 2020 have the advantages that when the target consensus node performs the second sub-verification, relevant information of the first root feature generated layer by layer upwards from the first tree features of the lowest layer corresponding to the digest value of the first target transaction is provided for the target consensus node, thus ensuring that the target consensus node can perform the correct second sub-verification. Irrelevant information of the first root feature generated layer by layer upwards from the first tree features of the lowest layer corresponding to the target consensus node are not provided for the target consensus node to the greatest extent, thus reducing information leakage of other transactions. Even the first bypass feature may be provided in the form of digest values, thus reducing real information leakage of related transactions.

In operation 2030, the digest algorithm may be used to acquire a digest of the first target transaction to acquire the digest value of the first target transaction. Operation 2030 and operation 2040 may use the digest algorithm. The digest value may be consistent with the digest algorithm used for generating the first tree in operation 2010 to ensure smoothness of the second sub-verification.

In operation 2040, the target consensus node determines the second root feature of the first tree based on the digest value of the first target transaction and the first verification information.

A process of determining the second root feature of the first tree includes: the first tree feature corresponding to the digest value of the first target transaction may be determined. The first tree features (as circled by a curve in FIG. 21B) on the first path, in the first tree, for generating the first root feature layer by layer upwards from the first tree features of the lowest layer corresponding to the first target transaction are reproduced according to the first bypass feature (the first verification information) and the first tree feature corresponding to the digest value of the first target transaction, to acquire the second root feature.

As shown in FIG. 21B, when the second root feature of the first tree is determined by using the first bypass feature (the first verification information) and the digest value of the first target transaction, it is assumed that the digest value of the first target transaction corresponds to the feature of the first tree feature 4, and extracted first bypass features include the features of the first tree feature 3, the first tree feature 7, and the first tree feature 12. The feature of the first tree feature 8 is generated according to the feature of the first tree feature 4 and the bypass feature of the first tree feature 3. The feature of the first tree feature 11 is generated according to the feature of the first tree feature 8 and the bypass feature of the first tree feature 7. The feature of the first tree feature 13 is generated according to the feature of the first tree feature 11 and the bypass feature of the first tree feature 12. The first tree feature 8, the first tree feature 11, and the first tree feature 13 on the first path, in the first tree, for generating the first root feature 13 layer by layer upwards from the first tree features 4 of the lowest layer corresponding to the digest value of the first target transaction are reproduced. The feature of the reproduced first tree feature 13 on the first path is taken as the second root feature.

After the second root feature is acquired in operation 2040, the target consensus node compares the second root feature with the digest value (the first root feature) of the first block body. In operation 2050, if the second root feature is consistent with the digest value of the first block body, the second sub-verification passes.

Through operation 2030 to operation 2050, some embodiments guarantees that the target consensus node can accurately verify the first target transaction, and verification that the first target transaction is truly recorded without cheating is performed. The real information leakage of related transactions is reduced, and the security may be improved.

An execution environment where the target consensus node of some embodiments is located is divided into two cases. One case is that the target consensus node has a trusted execution environment, and the other case is that the target consensus node does not have a trusted execution environment. Apparently, the target consensus node in some embodiments belongs to the case without the trusted execution environment. Operation 340 will be described in detail below in a case that the target consensus node has the trusted execution environment.

Before the target consensus node having the trusted execution environment is described, related contents of the trusted execution environment are explained first.

Trusted execution environment (TEE): a secure computing solution based on hardware. A secure area is established in a central processing unit (CPU) by a software and hardware method to ensure confidentiality and integrity of programs and data loaded inside the secure area. The TEE divides hardware resources and software resources of a system into two execution environments-trusted part and untrusted part (common part). These two environments are isolated, and the untrusted part cannot access the storage and memory of the trusted part.

Trusted execution environment hardware key: the hardware key burned in the CPU when Intel produces the CPU. A private key of the trusted execution environment cannot be exported in any case, and the public key can be exported under a particular usage scenario, but Intel does not recommend this practice.

Based on the content of the trusted execution environment, in some embodiments, in a case that the target consensus network has a first trusted execution environment, the first trusted execution environment internally has a first security execution space and a first key, the first security execution space forbids external access to the first security execution space, and the first blocks of the first blockchain are encrypted with the first key.

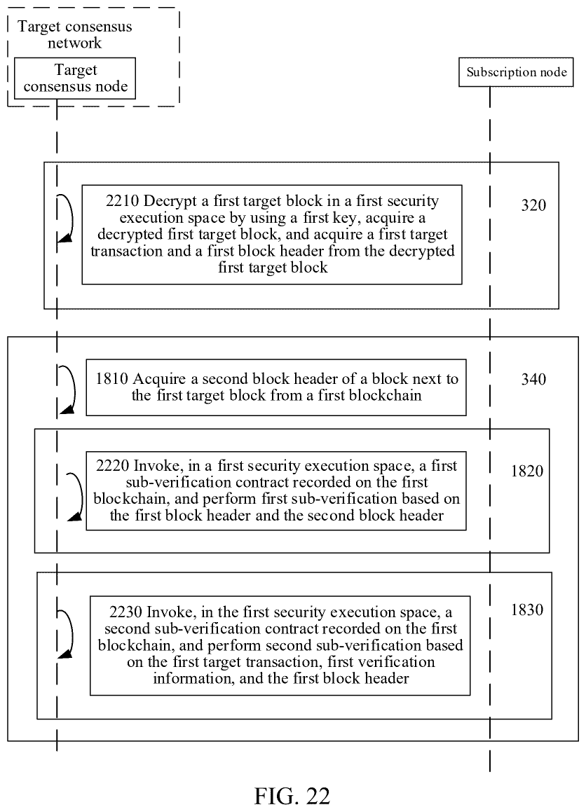

During implementation of some embodiments, with reference to FIG. 22, operation 320 includes:

Operation 2210: Decrypt the first target block in the first security execution space by using the first key, acquire a decrypted first target block, and acquire the first target transaction and the first block header from the decrypted first target block.

Correspondingly, operation 340 includes:

Operation 1810: Acquire the second block header of a block next to the first target block from the first blockchain.

Operation 1820 includes: Operation 2220: Invoke, in the first security execution space, a first sub-verification contract recorded on the first blockchain, and perform the first sub-verification based on the first block header and the second block header.

Operation 1830 includes: Operation 2230: Invoke, in the first security execution space, a second sub-verification contract recorded on the first blockchain, and perform the second sub-verification based on the first target transaction, the first verification information, and the first block header.

Operation 1810 is described in detail above, and will not be repeated herein. Operation 2210 to operation 2230 are described in detail below.

In operation 2210, since the first blocks of the first blockchain are encrypted with the first key, the target consensus network cannot directly read data from the first block after acquiring the first block from the first blockchain, and may decrypt the first block. A process of decrypting the first block by the target consensus network may be known by a third party, leading to information leakage and security decline. The target consensus network decrypts the first target block in the first security execution space. The first security execution space is established based on the trusted execution environment and cannot be accessed by the third party, thus ensuring information security. After the first target block is decrypted, the target consensus network can acquire the first target transaction and the first block header from the first target block.

In operation 2220, similar to operation 2210, on the basis that the third party cannot access the first security execution space, the target consensus network performs the first sub-verification in the first security execution space, thus ensuring information security. In operation 2220, the first verification contract is further invoked. The first verification contract refers to a contract for verifying the block header. The block header information is received, verified and stored in this first verification contract. For example, if a height of the first target block is 100, the first block header is a block header of 100. The target consensus network also acquires the first block with a height of 101, and the second block header is a block header of 101. The first verification contract verifies integrity of the block header of 100, and checks matching of the digest value of the block header of 100 and the digest value of the parent block header in the block header of 101, and the consensus information in the block header of 100. After the first sub-verification passes, the data of the first verification contract are provided for the “second verification contract” for verifying the transaction data.

In operation 2230, similar to operation 2220, on the basis that the third party cannot access the first security execution space, the target consensus network performs the second sub-verification in the first security execution space, thus ensuring information security. In operation 2230, the second verification contract is further invoked. The second verification contract refers to a contract for verifying the transaction. For example, the second verification contract is assumed to receive a particular first target transaction from the first target block (the height of the first target block is 100, and the first block header is the block header of 100). During the verification of the second verification contract, the digest value of the first target transaction is computed at first according to the first target transaction, and the first root feature is computed according to the first bypass feature of the first path in the first verification information. The first root feature is compared with the second root feature in the block header of 100 acquired from the “first verification contract”. If the comparison passes, the second sub-verification passes.

Some embodiments has the advantage that the trusted execution environment is used to ensure the security of the upload verification. The first verification contract is further used to verify the security of the first target block where the first target transaction is located, and the second verification contract is used to verify the security of the first target transaction itself, thus ensuring the accuracy of the upload verification.

Operation 340 is described in detail above.

### Detailed Description of Operation 360

Operation 360: Transmit the transaction result data to a subscription node for a local consensus network to acquire the transaction result data from the subscription node.

After the subscription node receives the transaction result data transmitted by the target consensus network, the subscription node may actively transmit the transaction result data to the local consensus network. The subscription node may also respond to reception of the transaction result data acquisition request of the local consensus network, and then transmit the transaction result data to the local consensus network.

In a case that the subscription node receives the transaction result data acquisition request, the local consensus network may generate the transaction result data acquisition request according to actual demand. For example, after the local consensus network transmits the first transaction of the target type to the target consensus network, and after a particular period of time, the local consensus network generates and transmits the transaction result data acquisition request to the subscription node and acquires the transaction result data from the subscription node. When the subscription node receives the transaction result data acquisition request from the local consensus network, the subscription node may not receive the transaction result data transmitted by the target consensus network yet, and the subscription node cannot reply to the local consensus network, resulting in waste of the processing resources. In view of that, some embodiments that can guarantee the subscription node to reply to the local consensus network in time will be provided below.

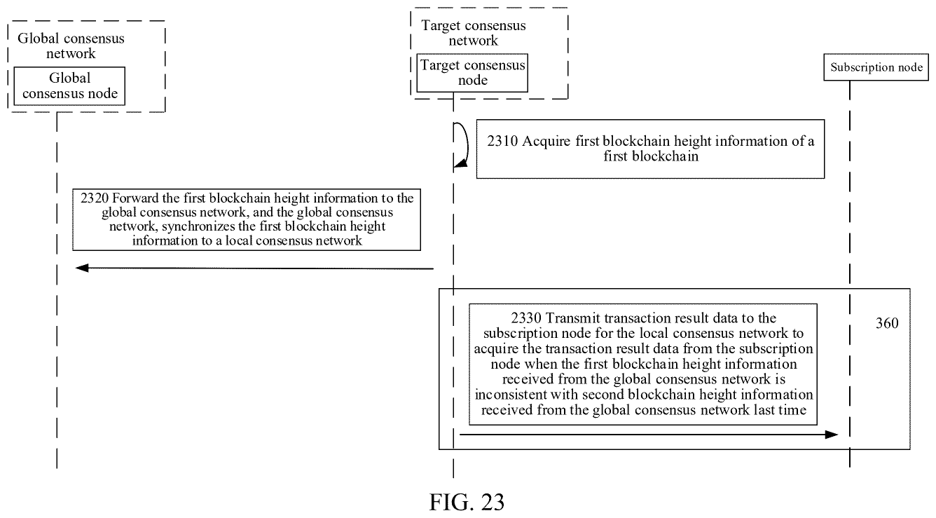

During implementation of some embodiments, with reference to FIG. 23, after operation 310, the method for processing a transaction of a blockchain (performed by the target consensus network) further includes:

Operation 2310: Acquire first blockchain height information of the first blockchain.

Operation 2320: Forward the first blockchain height information to a global consensus network, and the global consensus network synchronizes the first blockchain height information to the local consensus network,

Correspondingly, operation 360 includes: Operation 2330: Transmit the transaction result data to the subscription node for the local consensus network to acquire the transaction result data from the subscription node when the first blockchain height information received from the global consensus network is inconsistent with second blockchain height information received from the global consensus network last time.

Operation 2310 to operation 2330 are described in detail below.

In operation 2310, the first blockchain height information refers to the height information of the first blockchain, and the height of the first blockchain refers to a number of the first blocks. With reference to the first blockchain height counter set in operation 410, the target consensus network may read the first blockchain height information from the first blockchain height counter. Other methods may be adopted to acquire the first blockchain height information.

In operation 2320, the target consensus network may directly forward the first blockchain height information to the global consensus network, and the global consensus network forwards the first blockchain height information to the local consensus network. The target consensus network may forward directly the first blockchain height information to the global consensus network, and the global consensus network responds to a request from the local consensus network and then forwards the first blockchain height information to the local consensus network. For example, with reference to FIG. 1, the target consensus network may forward the first blockchain height information to the second relay node. The second relay node forwards the first blockchain height information to the global consensus network, the global consensus network forwards the first blockchain height information to the first relay node, and the first relay node forwards the first blockchain height information to the local consensus network.

In operation 2330, the target consensus network transmits the transaction result data to the subscription node, but the subscription node does not actively forward the transaction result data to the local consensus network, and the local consensus network may actively make a request to the subscription node. The local consensus network makes a request to the subscription node when the first blockchain height information and the second blockchain height information are inconsistent. If the first blockchain height information and the second blockchain height information are inconsistent, the first transaction of the target type is recorded on the first blockchain by the target consensus network. The first transaction of the target type is successfully uploaded. After learning that the first transaction of the target type is successfully uploaded, the local consensus network may naturally transmit a transaction result data acquisition request to the subscription node. The subscription node may respond to reception of the transaction result data and reply the local consensus network in time with the transaction result data.

Some embodiments has the advantage that a success rate of the local consensus network requesting the subscription node to acquire the transaction result data may be improved based on the first blockchain height information.

Operation 340 is described in detail above.

### Detailed Description of the First Transaction of the Target Type in Operation 310

Operation 310 to operation 360 are described in detail based on the content described above. The first block mentioned in operation 310 is generated by the target consensus network, and the first block is configured to record the first transaction of the target type from the local consensus network. With reference to FIG. 1, cross-chain information forwarding between the local consensus network and the target consensus network may be implemented by the first relay node. In some embodiments, the first relay node may acquire the first transaction of the target type from the local consensus network, and the first relay node forwards the first transaction of the target type to the target consensus network.

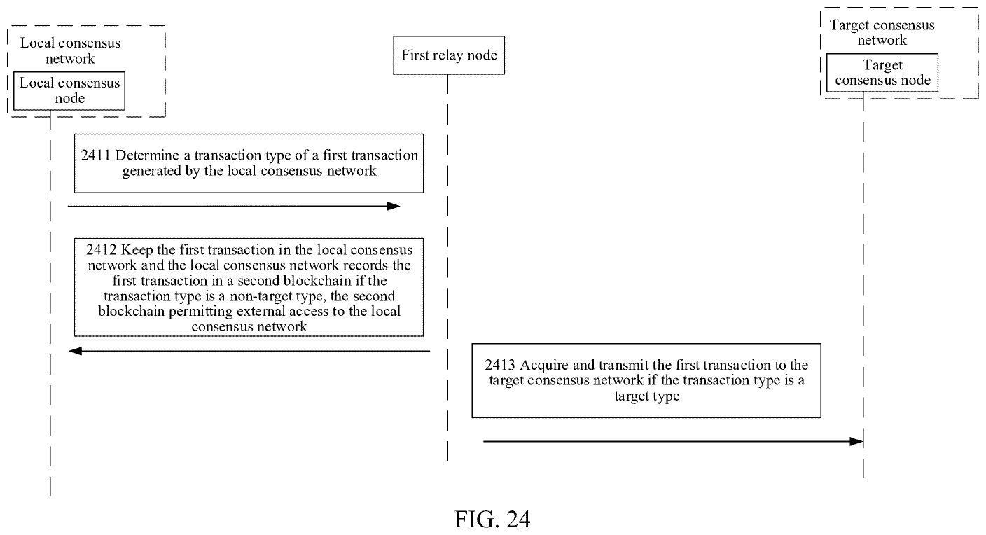

During implementation of some embodiments, with reference to FIG. 24, the first transaction of the target type is acquired by the first relay node and transmitted to the target consensus network in the following method:

Operation 2411: Determine a transaction type of the first transaction generated by the local consensus network.

Operation 2412: Keep the first transaction in the local consensus network and record, by the local consensus network, the first transaction in the second blockchain if the transaction type is a non-target type, the second blockchain permitting external access to the local consensus network.

Operation 2413: Acquire and transmit the first transaction to the target consensus network if the transaction type is the target type.

Operation 2411 to operation 2413 are described in detail below.

In operation 2411, the transaction type includes the target type and a non-target type. The target type refers to the type of transactions that is not allowed to be known to the outside. The non-target type refers to the type of transactions that is allowed to be known to the outside.

The first relay node is a module configured to determine the type of the first transaction and forward the first transaction of the target type. The first relay node may be an independent device, such as a separate computer or server. The subscription node may be part of an independent device, such as a virtual machine partitioned on the server.

In some embodiments, methods for determining the type of the first transaction include, but are not limited to, the following:

(1) A key fields is extracted from the contents of the first transaction, and a comparison table of the field and the type is searched according to the key field to determine the transaction type of the first transaction. An example of the comparison table of the field and the type is provided below:

TABLE 7

| Key field | Transaction type |
|---|---|
| Invoice | Target type |
| Resource | Target type |
| Weather | Non-target type |

As shown in Table 7, for the invoice as the key field, the first transaction is not allowed to be disclosed to the outside, such that it is determined that the transaction type of the first transaction is the target type. For the resource as the key field, the first transaction is not allowed to be disclosed to the outside either, such that it is determined that the type of the first transaction is the target type. For the weather as the key field, the first transaction is allowed to be disclosed to the outside, such that it is determined that the type of the first transaction is the non-target type.

For example, the first transaction is “100 first resources are converted into 10 second resources”, and the first key field included is the “resource”, such that it is determined that the transaction type of the first transaction is the target type. For example, the first transaction is “weather 10001: sunny on Month XX, Day XX”, and the key field included is the “weather”, such that it is determined that the type of the first transaction is the non-target type.

(2) A type identifier is acquired from the content of the first transaction, and the type of the first transaction is determined according to the type identifier.

For example, the content of the first transaction includes “100 first resources are converted into 10 second resources; [target type]”, and it is determined that the transaction type of the first transaction is the target type according to the “[target type]” included in the content. For example, the content of the first transaction includes “weather 10001: sunny on Month XX, Day XX; [non-target type]”, and it is determined that the transaction type of the first transaction is the non-target type according to the “[non-target type]” included in the content.

In operation 2412, a common service smart contract (such as an order smart contract below) is run on the local consensus network, and service logic is publicly embodied in contract codes. The first transaction interacting with the common service smart contract is executed on the local consensus node, and execution results are also recorded on the second blockchain maintained by the local consensus node. These execution results may also be returned to the global consensus network in the core consensus network through the first relay node.

For example, the first transaction of the non-target type assumed to be “order 10001: 50 pieces of office supplies are purchased”. Then the local consensus node invokes the order smart contract to execute the first transaction, and the execution result is “completed: order 10001: 50 pieces of office supplies are purchased”. The execution result is recorded on the second blockchain by the local consensus node, and all nodes except the local consensus node may access the second blockchain.

In operation 2413, since the first transaction of the target type is a transaction that is not expected to be accessed and known to the third party, the first relay node transmits the first transaction of the target type to the target consensus network, and the target consensus network responds to reception of the first transaction of the target type, and executes and records the first transaction on the first blockchain. Since the target transaction is the transaction that is not expected to be accessed or known to the third party, consent from an object generating the first transaction is to be sought before the first transaction is uploaded. A query box may be displayed to the object to ask whether the object consents to upload the first transaction of the target type. If the object does not consent, some embodiments may not be implemented, or part of the transaction with upload consent is uploaded.

Through operation 2411 to operation 2413, some embodiments utilizes a capacity of the local consensus network to execute the first transaction of the non-target type and return the first transaction of the target type in the local consensus network through the first relay node, thus separating the first transaction and safely uploading the first transaction of the target type. For example, the first transaction of the target type is executed and recorded in the target consensus network, and computation processes and computation logic as well as intermediate results are all completed in the target consensus network. Consensus of the target consensus network and the upload verification in the target consensus network can effectively use the tamper-proof feature of the blockchain for guaranteeing correctness and credibility of the transaction.

### Detailed Description of Transaction Result Data in Operation 350 to Operation 360

In some embodiments, the transaction result data are variables affected by execution of the first target transaction.

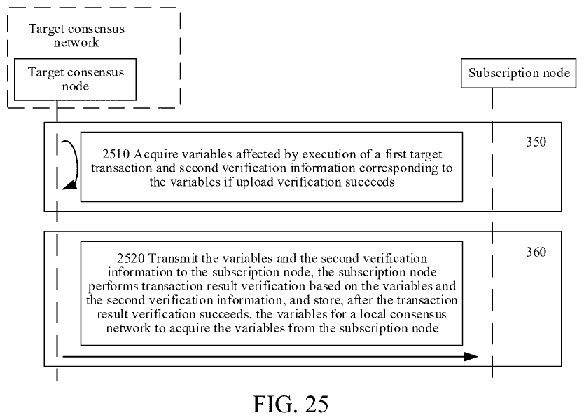

During implementation of some embodiments, with reference to FIG. 25, operation 350 includes:

Operation 2510: Acquire the variables affected by the execution of the first target transaction and second verification information corresponding to the variables if the upload verification succeeds.

Correspondingly, operation 360 includes:

Operation 2520 includes: transmit the variables and the second verification information to the subscription node, perform, by the subscription node, transaction result verification based on the variables and the second verification information, and store, after the transaction result verification succeeds, the variables for the local consensus network to acquire the variables from the subscription node.

Operation 2510 to operation 2520 are described in detail below.

In operation 2510, the variables affected by the execution of the first target transaction refer to parameters that may be affected by the execution of the first transaction, such as a total amount of resources or an amount of goods. For example, the first target transaction is “electronic invoice reimbursement 0001, an amount of 500”. After the transaction is executed and uploaded, the total amount of enterprise resources may be affected. Assuming that a total amount of original enterprise resources are 5000, after the electronic invoice is reimbursed, the total amount of resources becomes 4500. The total amount of resources is a variable affected by execution of invoice reimbursement. For example, the first target transaction is “an enterprise A is presented with 600 movie tickets”. The remaining amount of movie tickets in a cinema after execution of the transaction may be affected. Assuming that there are original 5000 movie tickets in the cinema, the amount of movie tickets in the cinema becomes 4400 after the transaction is executed and uploaded. The amount of movie tickets is a variable after the execution of the ticket presentation transaction. To verify the variable after the execution of the first target transaction, the second verification information corresponding to the variable may be acquired.

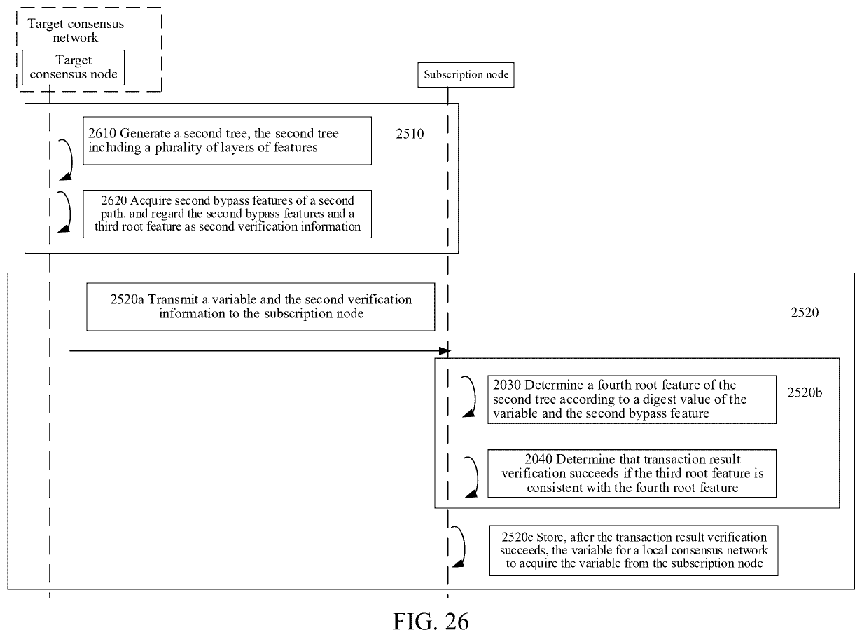

With reference to FIG. 26, in some embodiments, the operation that the second verification information corresponding to the variable is acquired includes:

Operation 2610: Generate a second tree, the second tree including a plurality of layers of features.

Operation 2620: Acquire second bypass features of a second path, and regard the second bypass features and a third root feature as the second verification information.

Operation 2610 to operation 2620 are described in detail below.

In operation 2610, a lowest layer of features of the second tree is digest values of the variables affected by execution of the first transactions, the first transactions include the first target transaction. Order of the features at the lowest layer of the second tree may be pre-specified variable order. For example, the order of enterprises A, B, C, D . . . is taken as the order of the features of the lowest layer of the second tree. When the target consensus network receives the first transaction 1 “an employee X reimburses 1000 resources in an enterprise B”, this transaction causes a change in the total amount of resources of the enterprise B, and makes the total amount of resources of the enterprise B change to 49000. The second feature (namely the second tree feature 2) of the lowest layer of features is changed to a digest value of 49000. When the target consensus network receives the first transaction 2 “an employee Y reimburses 500 resources in an enterprise D”, this transaction causes a change in the total amount of resources of the enterprise D, and makes the total amount of resources of the enterprise D change to 24500. The fourth feature (namely the second tree feature 4) of the lowest layer of features is changed to a digest value of 24500. Similar to the previous embodiment in FIG. 21A to FIG. 21B, the digest value herein may be obtained through a fixed digest algorithm that is the same for entities to which the first transactions belong and is pre-specified by the target consensus network, or through different digest algorithms pre-specified by the target consensus network for entities to which the first transactions belong, which is not repeated herein.

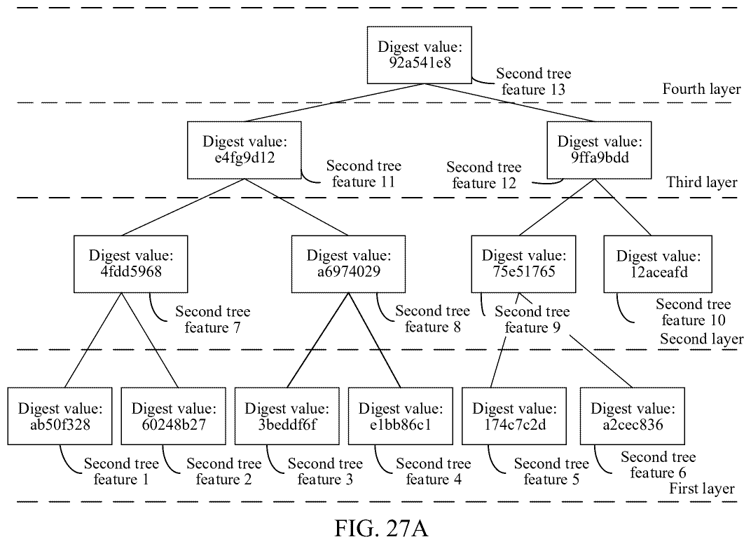

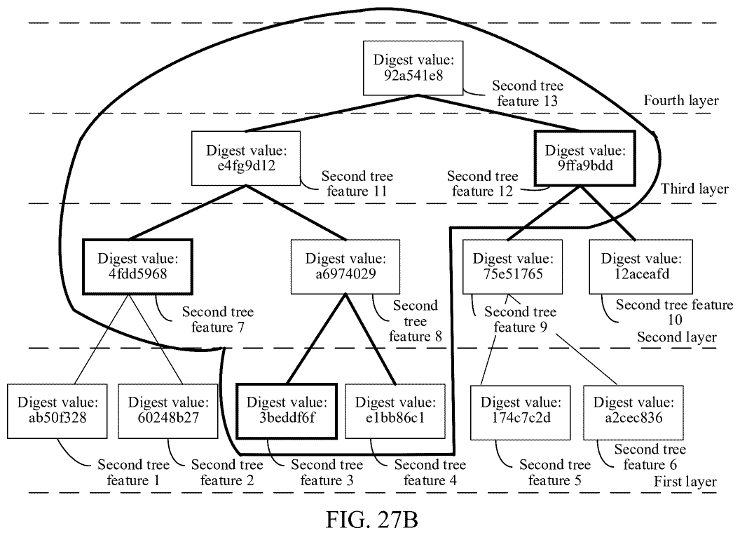

Two adjacent features of each layer of the second tree are connected to and generate a feature of an upper layer until the third root feature of the second tree is generated. A structure and a generation process of the second tree are similar to the structure and the generation process of the first tree, such that reference may be made to the description of generating the first tree with reference to FIG. 21A for a process of generating the second tree with reference to FIG. 27Ain.

In operation 2620, the second path is a path between a digest value of the variable affected by the execution of the first target transaction on the second tree and the third root feature, and the second bypass features are lower layers of features to which other features on the second path except the variable affected by the execution of the first target transaction are connected.

During implementation of some embodiments, operation 2620 is similar to the implementation process when the feature of the first tree is the digest value of the first transaction. A difference is that the second tree feature of the second tree in some embodiments is the variable affected by the execution of the first transaction, while the first tree feature of the first tree in the above embodiment is the digest value of the first transaction. To save space, no repeat will be provided.

As shown in FIG. 27B, by assuming that the feature of the digest value of the variable affected by the execution of the first transaction corresponds to the second tree feature 4, and the third root feature of the second tree corresponds to the second tree feature 13, the second path is the path from the second tree feature 4 to the second tree feature 13 on the second tree. The second path covers connection paths between the second tree feature 4, the second tree feature 8, the second tree feature 11, and the second tree feature 13. The second bypass features of the second path include the features of the second tree feature 3, the second tree feature 7, and the second tree feature 12, and the second bypass features are denoted with thick black boxes in FIG. 27B. Other features in the second tree except the second bypass features and the lowest layer of features corresponding to the digest value of the variable affected by the execution of the first transaction are not provided for the target consensus network.

Operation 2610 to operation 2620 have the advantage that the target consensus node can perform correct second sub-verification, but irrelevant information of the first root feature generated layer by layer upwards from the first tree features of the lowest layer corresponding to the target consensus node are not provided for the target consensus node to the greatest extent, thus reducing information leakage of other transactions. Even the first bypass feature may be provided in the form of digest values, thus reducing real information leakage of related transactions.

Operation 2510 is described in detail above.

With reference to FIG. 25, operation 2520 includes: 2520a: transmit the variables and the second verification information to the subscription node, 2520b: the subscription node performs transaction result verification based on the variables and the second verification information, and 2520c: store, after the transaction result verification succeeds, the variables for the local consensus network to acquire the variables from the subscription node.

In some embodiments, with reference to FIG. 26, operation 2520b includes:

Operation 2630: Determine the fourth root feature of the second tree according to the digest value of the variable and the second bypass feature.

Operation 2640: Determine that the transaction result verification succeeds if the third root feature is consistent with the fourth root feature.

Operation 2630 to operation 2640 are described in detail below.

In operation 2630, a process of determining the fourth root feature of the second tree includes: the second tree feature corresponding to the digest value of the variable may be determined. The second tree features (as circled by a curve in FIG. 27B) on the second path, in the second tree, for generating the second root feature layer by layer upwards from the second tree features of the lowest layer corresponding to the digest value of the variable are reproduced according to the second bypass feature and the second tree feature corresponding to the digest value of the variable, to acquire the fourth root feature. Reference may be made to the description of generating the second root feature with reference to FIG. 21B for a process of generating the fourth root feature with reference to FIG. 27Bin.

After the fourth root feature is acquired in operation 2630, the subscription node compares the third root feature with the fourth root feature. In operation 2640, the transaction result verification succeeds if the third root feature is consistent with the fourth root feature.

Through operation 2630 to operation 2640, the subscription node can verify whether the transaction result data are authentic through the variables affected by execution of the transaction, thus improving the security of information transmission.

Similar to the target consensus network, the subscription nodes may be divided into two cases of subscription nodes that have the trusted execution environment and subscription nodes that do not have the trusted execution environment. Some embodiments described above belongs to the case that there is no trusted execution environment, and the subscription node having the trusted execution environment is described in detail below.

In some embodiments, the subscription node has the second trusted execution environment, the second trusted execution environment internally has a second security execution space and a second key, and the second security execution space forbids external access to the second security execution space.

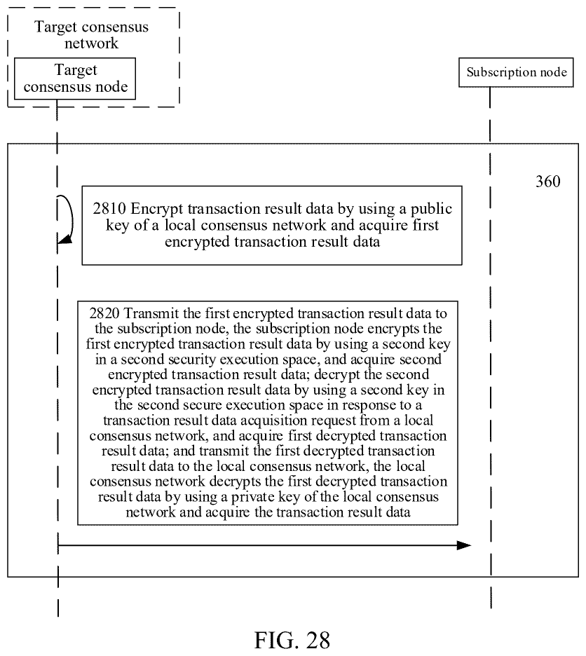

During implementation of some embodiments, with reference to FIG. 28, operation 360 includes:

Operation 2810: Encrypt the transaction result data by using a public key of the local consensus network, and acquire first encrypted transaction result data.

Operation 2820: Transmit the first encrypted transaction result data to the subscription node, the subscription node encrypts the first encrypted transaction result data by using the second key in the second security execution space, and acquire second encrypted transaction result data. Decrypt the second encrypted transaction result data by using the second key in the second secure execution space in response to a transaction result data acquisition request from the local consensus network, and acquire first decrypted transaction result data. Transmit the first decrypted transaction result data to the local consensus network, the local consensus network decrypts the first decrypted transaction result data by using a private key of the local consensus network and acquire the transaction result data.

Processes of encrypting and decrypting by the subscription node based on the second trusted execution environment in operation 2810 to operation 2820 are similar to processes of encrypting and decrypting by the target consensus network based on the first trusted execution environment in operation 2210 to operation 2230 except a difference below. Operation 2810 to operation 2820 ensure the security of transaction result data in the subscription node by using the second trusted execution environment, while operation 2210 to operation 2230 ensure the security of the first target block by using the first trusted execution environment. To save space, no repeat will be provided herein.

### Detailed Diagram of Implementing a Method for Processing a Transaction of a Blockchain According to Some Embodiments

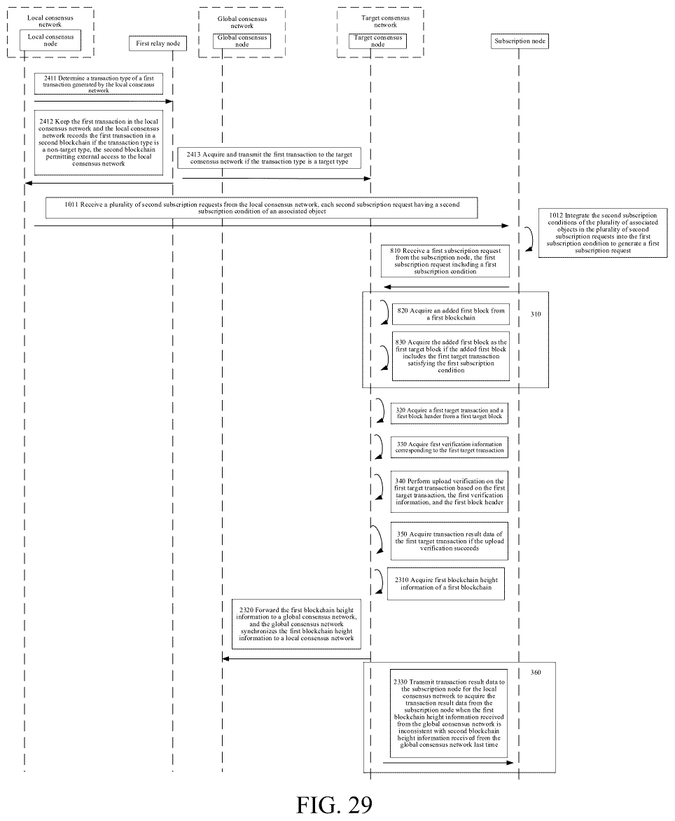

With reference to FIG. 29, the method for processing a transaction of a blockchain according to some embodiments is exemplarily described in detail below.

In operation 2411 (executed by the first relay node), the transaction type of the first transaction generated by the local consensus network is determined.

In operation 2412 (executed by the first relay node), the first transaction is kept in the local consensus network, and the local consensus network records the first transaction in the second blockchain if the transaction type is a non-target type, and the second blockchain permits external access to the local consensus network.

In operation 2413 (executed by the first relay node), the first transaction is acquired and transmitted to the target consensus network if the transaction type is the target type, and the target consensus network generates the first block based on the first target transaction and records the first block on the first blockchain.

In operation 1011 (executed by the subscription node), a plurality of second subscription requests are received from the local consensus network, and each second subscription request has a second subscription condition of an associated object.

In operation 1012 (executed by the subscription node), the second subscription conditions of the plurality of associated objects in the plurality of second subscription requests are integrated into the first subscription condition to generate the first subscription request.

Operation 330 is divided into operation 810 to operation 830.

In operation 810 (executed by the target consensus node), a first subscription request is received from the subscription node, and the first subscription request includes the first subscription condition.

In operation 820 (executed by the target consensus node), the added first block is acquired from the first blockchain.

In operation 830 (executed by the target consensus node), the added first block is acquired as the first target block if the added first block includes the first target transaction satisfying the first subscription condition.

In operation 320 (executed by the target consensus node), a first target transaction and a first block header are acquired from the first target block.

In operation 330 (executed by the target consensus node), first verification information corresponding to the first target transaction is acquired.

In operation 340 (executed by the target consensus node): upload verification is performed on the first target transaction based on the first target transaction, the first verification information, and the first block header.

In operation 350 (executed by the target consensus node), transaction result data of the first target transaction are acquired if the upload verification succeeds.

In operation 2310 (executed by the target consensus node), the first blockchain height information of the first blockchain is acquired.

In operation 2320 (executed by the target consensus node), the first blockchain height information is forwarded to a global consensus network, and the global consensus network synchronizes the first blockchain height information to the local consensus network.

In operation 2330 (executed by the target consensus node), the transaction result data are transmitted to the subscription node for the local consensus network to acquire the transaction result data from the subscription node when the first blockchain height information received from the global consensus network is inconsistent with second blockchain height information received from the global consensus network last time.

Some embodiments has the advantages including but not limited to: some embodiments is based on a multi-layer chain framework and for large-scale service in the form of blockchain electronic invoices. The form of multi-layer chain is conducive to hierarchical service governance, local blockchains can be guaranteed to run local-level services independently without collecting all traffic of an entire service alliance into the global blockchain. The roles of data isolation, service privacy isolation, and legal compliance are played, and the global consensus network can be guaranteed to focus on key tasks and global governance without carrying a large number of subdivided services. The first transaction of the target type is executed and recorded in the target consensus network, and computation processes and computation logic as well as intermediate results are all completed in the target consensus network. External access is forbidden, and the transaction upload security may be improved. The plurality of second subscription conditions are simultaneously transmitted by using one subscription request, thus saving network resources. The target consensus network can process the plurality of second subscription conditions in batches, thus improving processing efficiency. By regarding the first block that includes the first target transaction satisfying the first subscription condition as the first target block, the number of the first blocks subject to upload verification can be reduced, and processing resources can be saved. A success rate of the local consensus network requesting the subscription node to acquire the transaction result data may be improved based on the first blockchain height information. Trusted upload result interaction can be performed without reading the first blockchain information.

### Description of an Apparatus and a Device According to Some Embodiments

Although steps in the flowcharts are shown in sequence as indicated by arrows, these steps are not necessarily performed in order indicated by the arrows. Unless explicitly stated in some embodiments, performing of these steps is not strictly limited in order, and these steps can be performed in another order. At least some steps in the flowchart can include a plurality of steps or a plurality of stages. These steps or stages are not necessarily performed at the same time, and can be performed at different time. Performing order of these steps or stages is not necessarily sequential, and these steps or stages can be performed by turns or alternately with other steps or at least some steps or stages of the other steps.

In some embodiments, when related processing may be performed according to data related to the feature of the target object, such as attribute information or attribute information sets of the target object, permission or consent from the target object is obtained at first. Collection, use, processing, for example of these data abide by relevant laws, regulations and standards. When some embodiments of the present application may acquire the attribute information of the target object, individual permission or individual consent from the target object is obtained through a pop-up window or redirection to a confirmation page. After the individual permission or individual consent from the target object is explicitly obtained, necessary relevant data of the target object for normal running of some embodiments are acquired.

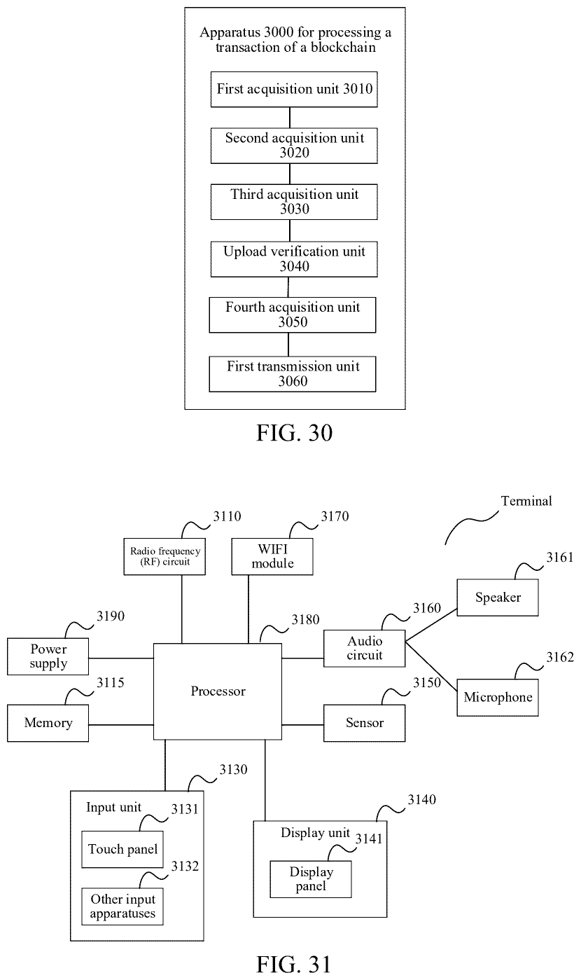

FIG. 30 shows a schematic structural diagram of an apparatus 3000 for processing a transaction of a blockchain according to some embodiments. The apparatus for processing a transaction of a blockchain is located in the target consensus network. With reference to FIG. 30, the apparatus 3000 for processing a transaction of a blockchain includes:

a first acquisition unit 3010 configured to acquire an added first target block from first blocks of a first blockchain, the first block being generated by the target consensus network and being configured to record a first transaction of a target type from a local consensus network, and the first blockchain forbidding external access to the target consensus network;

a second acquisition unit 3020 configured to acquire a first target transaction and a first block header from the first target block;

a third acquisition unit 3030 configured to acquire first verification information corresponding to the first target transaction;

an upload verification unit 3040 configured to perform upload verification on the first target transaction based on the first target transaction, the first verification information, and the first block header;

a fourth acquisition unit 3050 configured to acquire transaction result data of the first target transaction if the upload verification succeeds; and

a first transmission unit 3060 configured to transmit the transaction result data to a subscription node for the local consensus network to acquire the transaction result data from the subscription node.

In some embodiments, the upload verification includes first sub-verification and second sub-verification.

The upload verification unit 3040 may be configured to:

acquire a second block header of a block next to the first target block from the first blockchain;

perform the first sub-verification based on the first block header and the second block header; and

perform the second sub-verification based on the first target transaction, the first verification information, and the first block header.

In some embodiments, the block header of the first block includes a digest value of a first block body of the first block and a digest value of a second block body of a block previous to the first block on the first blockchain.

The upload verification unit 3040 is further configured to:

determine that the first sub-verification succeeds if the digest value of the first block body in the first block header is equal to the digest value of the second block in the second block header.

In some embodiments, the third acquisition unit 3030 may be configured to:

generate a first tree, the first tree including a plurality of layers of features, and a lowest layer of features of the first tree being digest values of a plurality of first transactions in the first target block; the plurality of first transactions including the first target transaction, and two adjacent features of each layer of the first tree being connected to and generate a feature of an upper layer until the first root feature of the first tree is generated; and the first root feature being the digest value of the first block body; and

acquire first bypass features of the first path as the first verification information, the first path being a path between a digest value of the first target transaction on the first tree and the first root feature, and the first bypass features being lower layers of features to which other features on the first path except the digest value of the first target transaction are connected.

The upload verification unit 3040 is further configured to:

determine a digest value of the first target transaction;

determine a second root feature of the first tree based on the digest value of the first target transaction and the first verification information; and

determine that the second sub-verification succeeds if the second root feature is equal to the digest value of the first block body in the first block header.

In some embodiments, the target consensus network has a first trusted execution environment, the first trusted execution environment internally has a first security execution space and a first key, the first security execution space forbids external access to the first security execution space, and the first blocks of the first blockchain are encrypted with the first key.

The second acquisition unit 3020 may be configured to: decrypt the first target block in the first security execution space by using the first key, acquire a decrypted first target block, and acquire the first target transaction and the first block header from the decrypted first target block.

The upload verification unit 3040 is further configured to: invoke, in the first security execution space, a first sub-verification contract recorded on the first blockchain, and perform the first sub-verification based on the first block header and the second block header.

The upload verification unit 3040 is further configured to: invoke, in the first security execution space, a second sub-verification contract recorded on the first blockchain, and perform the second sub-verification based on the first target transaction, the first verification information, and the first block header.

In some embodiments, after the acquiring of the added first target block from the first blocks of the first blockchain, the apparatus 3000 for processing a transaction of a blockchain further includes:

a fifth acquisition unit configured to acquire first blockchain height information of the first blockchain; and

a second transmission unit configured to forward the first blockchain height information to a global consensus network, and synchronize, by the global consensus network, the first blockchain height information to the local consensus network.

The first transmission unit 3060 may be configured to: transmit the transaction result data to the subscription node for the local consensus network to acquire the transaction result data from the subscription node when the first blockchain height information received from the global consensus network is inconsistent with second blockchain height information received from the global consensus network last time.

In some embodiments, the first transaction of the target type is acquired by the first relay node and transmitted to the target consensus network by the following method:

determine a transaction type of the first transaction generated by the local consensus network;

keep the first transaction in the local consensus network and record, by the local consensus network, the first transaction in the second blockchain if the transaction type is a non-target type, the second blockchain permitting external access to the local consensus network; and

acquire and transmit the first transaction to the target consensus network if the transaction type is the target type.

In some embodiments, the first acquisition unit 3010 may be configured to:

set a first blockchain height counter, the first blockchain height counter being increased by 1 when one first block is added to the first blockchain;

acquire, if a difference between a current first value of the first blockchain height counter and a second value of the first blockchain height counter when the added first target block is acquired last time reaches a first threshold, the first blocks on the first blockchain from a block height of the second value plus 1 to a block height of the first value as the first target block; and

acquire, if a difference between the current first value of the first blockchain height counter and the second value of the first blockchain height counter when the added first target block is acquired last time fails to reach the first threshold, but a time difference between a current time point and a time point of acquiring the added first target block last time reaches the second threshold, the first block added within the time difference as the first target block.

In some embodiments, before the acquiring of the added first target block from the first blocks of the first blockchain, the apparatus 3000 for processing a transaction of a blockchain further includes:

a first reception unit configured to receive a first subscription request from the subscription node, the first subscription request including the first subscription condition.

The first acquisition unit 3010 is further configured to:

acquire the added first block from the first blockchain; and

acquire the added first block as the first target block if the added first block includes the first target transaction satisfying the first subscription condition.

In some embodiments, the first subscription request further has a subscription deadline.

The first acquisition unit 3010 is further configured to:

determine a valid subscription request whose subscription deadline does not expire from the first subscription request; and

acquire the added first block as the first target block if the added first block includes the first target transaction satisfying the first subscription condition of the valid subscription request.

In some embodiments, before the receiving of the first subscription request from the subscription node, the apparatus 3000 for processing a transaction of a blockchain further includes:

a second reception unit configured to receive a registration request from the subscription node, the registration request including a private key of the subscription node; and record the private key of the subscription node on the first blockchain.

The first subscription request includes the private key of the subscription node.

After the receiving of the first subscription request from the subscription node, the apparatus 3000 for processing a transaction of a blockchain further includes:

a private key verification unit configured to verify that the private key included in the first subscription request is consistent with the private key recorded on the first blockchain.

In some embodiments, the subscription nodes are the plurality of subscription nodes corresponding to the plurality of transaction subtypes, and the first subscription condition is the transaction subtype corresponding to the subscription node.

The first transmission unit 3060 is further configured to: transmit the transaction result data to the subscription node corresponding to the transaction subtype.

In some embodiments, the first transaction in the first block includes an identifier of the associated object, and the subscription nodes are the plurality of subscription nodes corresponding to the plurality of object sets. The first subscription condition is that the identifier of the associated object of the first transaction belongs to the object set corresponding to the subscription node.

The first transmission unit 3060 is further configured to: transmit the transaction result data to the subscription node corresponding to the identifier of the associated object.

In some embodiments, the second acquisition unit 3020 is further configured to: acquire, if a number of first transactions satisfying the first subscription condition among a plurality of the first transactions is greater than 1, the first transactions satisfying the first subscription condition as the first target transaction in predetermined order, the predetermined order being determined by the following method:

determine first priority of associated objects of the first transactions;

determine second priority of the subscription node corresponding to the first subscription condition; and

determine the predetermined order according to the first priority and the second priority.

In some embodiments, the second acquisition unit 3020 is further configured to:

determine a first score of the first transaction according to the first priority;

determine a second score of the first transaction according to the second priority;

determine a total score of the first transaction based on the first score and the second score; and

determine the predetermined order based on the total score of the first transaction.

In some embodiments, the transaction result data are variables affected by execution of the first target transaction.

The fourth acquisition unit 3050 may be configured to: acquire the variables affected by the execution of the first target transaction and second verification information corresponding to the variables if the upload verification succeeds.

The first transmission unit 3060 is further configured to: transmit the variables and the second verification information to the subscription node, perform, by the subscription node, transaction result verification based on the variables and the second verification information, and store, after the transaction result verification succeeds, the variables for the local consensus network to acquire the variables from the subscription node.

In some embodiments, the fourth acquisition unit 3050 is further configured to:

generate the second tree, the second tree including a plurality of layers of features, a lowest layer of features of the second tree being digest values of the variables affected by execution of the first transactions, the first transactions including the first target transaction, and two adjacent features of each layer of the second tree being connected to and generating a feature of an upper layer until the third root feature of the second tree is generated; and

acquire second bypass features of a second path, and regard the second bypass feature and the third root feature as the second verification information, the second path being a path between a digest value of the variable affected by the execution of the first target transaction on the second tree and the third root feature, and the second bypass features being lower layers of features to which other features on the second path except the variable affected by the execution of the first target transaction are connected.

The first transmission unit 3060 is further configured to:

determine a fourth root feature of the second tree according to the digest value of the variable and the second bypass feature; and

determine that the transaction result verification succeeds if the third root feature is consistent with the fourth root feature.

In some embodiments, the subscription node has a second trusted execution environment, the second trusted execution environment internally has a second security execution space and a second key, and the second security execution space forbids external access to the second security execution space.

The first transmission unit 3060 is further configured to:

encrypt the transaction result data by using a public key of the local consensus network, and acquire first encrypted transaction result data; and

transmit the first encrypted transaction result data to the subscription node, encrypt, by the subscription node, the first encrypted transaction result data by using the second key in the second security execution space, and acquire second encrypted transaction result data; decrypt the second encrypted transaction result data by using the second key in the second secure execution space in response to a transaction result data acquisition request from the local consensus network, and acquire first decrypted transaction result data; and transmit the first decrypted transaction result data to the local consensus network, decrypt, by the local consensus network, the first decrypted transaction result data by using a private key of the local consensus network, and acquire the transaction result data.

With reference to FIG. 31, FIG. 31 shows a partial structural block diagram of a terminal implementing a method for processing a transaction of a blockchain according to some embodiments. The terminal includes: a radio frequency (RF) circuit 3110, a memory 3115, an input unit 3130, a display unit 3140, a sensor 3150, an audio circuit 3160, a wireless fidelity (WiFi) module 3170, a processor 3180, a power supply 3190, for example Those skilled in the art can understand that the terminal structure shown in FIG. 31 is not limited to a mobile phone or a computer, and may include more or few components than those shown, or combine some components, or have different component arrangements.

The RF circuit 3110 may be configured to receive and transmit signals in the process of transmitting and receiving information or calling, and receive and then provide downlink information of a base station for the processor 3180 to be processed. Designed upload data are transmitted to the base station.

The memory 3115 may be configured to store software programs and modules, and the processor 3180 executes various functional applications and data processing of a target terminal by running the software programs and modules stored in the memory 3115.

The input unit 3130 may be configured to receive input digital or character information and generate key signal input related to setting and function control of the target terminal. The input unit 3130 may include a touch panel 3131 and other input apparatuses 3132.

The display unit 3140 may be configured to display input information or provided information and various menus of the target terminal. The display unit 3140 may include a display panel 3141.

The audio circuit 3160, a speaker 3161, and a microphone 3162 may provide an audio interface.

In some embodiments, the processor 3180 included in the terminal may perform the method for processing a transaction of a blockchain of the previous embodiment.

The terminal of some embodiments may include, but is not limited to, a mobile phone, a computer, a smart voice interaction device, a smart household appliance, an in-vehicle terminal, an aircraft, for example Some embodiments may be applied to various scenarios, including but not limited to data security, blockchains, data storage, and information technology.

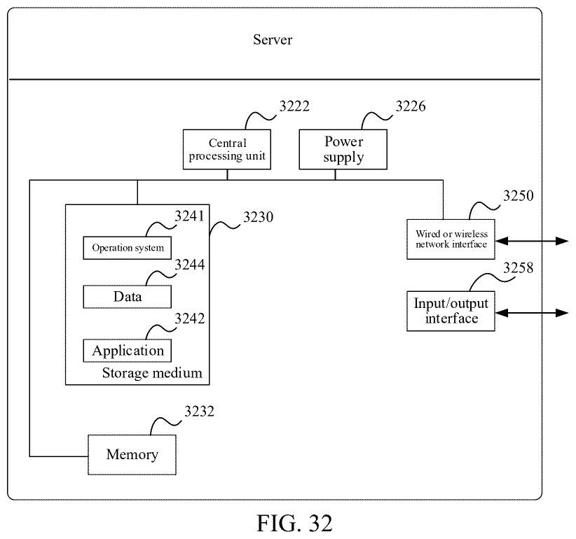

FIG. 32 shows a partial structural block diagram of a server implementing the method for processing a transaction of a blockchain according to some embodiments. The server may vary greatly due to different configurations or performances, and may include one or more central processing units (CPUs) 3222 (for example, one or more processors), a memory 3232, and one or more storage media 3230 (for example, one or more mass storage apparatuses) for storing applications 3242 or data 3244. The memory 3232 and the storage medium 3230 may be temporary storage or permanent storage. The program stored in the storage medium 3230 may include one or more modules, and each module may include a series of instruction operations in the server. The central processing unit 3222 may be configured to communicate with the storage medium 3230 and execute a series of instruction operations in the storage medium 3230 in the server.

The server may further include one or more power supplies 3226, one or more wired or wireless network interfaces 3250, one or more input and output interfaces 3258, and/or one or more operating systems 3241, such as Windows Server™, Mac OS X™, Unix™, Linux™ and FreeBSD™.

The central processing unit 3222 in the server may be configured to perform the method for processing a transaction of a blockchain of some embodiments.

Some embodiments further provide a computer-readable storage medium. The computer-readable storage medium is configured to store program codes, and the program codes are configured for performing the method for processing a transaction of a blockchain of some embodiments.

Some embodiments further provide a computer program product. The computer program product includes a computer program. The processor of the computer device reads and executes the computer program, and causes the computer device to perform the method for processing a transaction of a blockchain.

The terms “first”, “second”, “third”, “fourth” for example (if any) in the description and the accompanying drawings are used to distinguish similar objects, but are not necessarily used to describe sequence or sequential order. Data used in this way can be interchanged under appropriate cases, such that some embodiments described herein can be implemented in a sequence other than those illustrated or described herein, for example. Terms “comprise”, “include”, and their any variation are intended to cover non-exclusive inclusions. For example, processes, methods, systems, products, or apparatuses that include a series of steps or units are not necessarily limited to those steps or units clearly listed, but can include other steps or units not explicitly listed or inherent to these processes, methods, products, or apparatuses.

In the present disclosure, “at least one (item)” means one or more, and “plurality” means two or more. The term “and/or” is used to describe an association between associated objects and means three relations. For example, A and/or B can indicate three cases that A exists alone, B exists alone, and A and B exist and A and B can be singular or plural. The character “/” indicates that the associated objects in the context are in an “or” relation. The phase “at least one of the following items (pieces)” or its similar expression indicates any combination of these items, including any combination of single items (pieces) or plural items (pieces). For example, at least one of a, b or c may indicate a, b, c, “a and b”, “a and c”, “b and c” or “a and b and c”, and a, b and c may be single or plural.

In the description of some embodiments, the term plurality (or a plurality of items) indicates more than two, greater than, less than, over, for example and are understood as excluding this number, and the terms not less than, not more than, within, for example are understood as including this number.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

If the integrated units are implemented in the form of the software functional units and sold or used as independent products, they may be stored in the computer-readable storage medium. Based on such understanding, the technical solution can be embodied in the form of software products in essence or part that contributes to the related art or in entirety or part, the computer software products are stored in the storage medium, and include several instructions to make one computer apparatus (a personal computer, a server, a network device, for example) perform all or some steps of the method of the examples. The foregoing storage medium includes a USB flash drive, a mobile hard disk drive, a read-only memory (ROM), a random access memory (RAM), a diskette or optical disk, for example that may store program codes.

Some embodiments according to some embodiments can be combined in different manners to form some embodiments to achieve different technical effects.

The description described above is particular description of some embodiments, but the present disclosure is not limited to some embodiments described above. Those skilled in the art can make various equivalent variations or substitutions without violating the spirit conditions, and these equivalent variations or substitutions are to fall within the scope defined by the claims.

What is claimed is:

1. A method for processing a transaction of a blockchain, performed by a target consensus network, comprising:
acquiring an added first target block from one or more first blocks of a first blockchain, wherein the first target block is generated by the target consensus network and is configured for recording a first transaction of a target type from a local consensus network, and wherein the first blockchain forbids external access to the target consensus network;
acquiring a first target transaction and a first block header from the first target block;
acquiring first verification information corresponding to the first target transaction;
performing upload verification on the first target transaction based on the first target transaction, the first verification information, and the first block header;
acquiring transaction result data of the first target transaction if the upload verification succeeds; and
transmitting the transaction result data to a subscription node for the local consensus network to acquire the transaction result data from the subscription node.

2. The method according to claim 1, wherein the performing the upload verification comprises:
acquiring a second block header of a block next to the first target block from the first blockchain;
performing first sub-verification based on the first block header and the second block header; and
performing second sub-verification based on the first target transaction, the first verification information, and the first block header.

3. The method according to claim 2, wherein a block header of the first target block comprises a first digest value of a first block body of the first target block and a second digest value of a second block body of a second block previous to the first target block on the first blockchain, and
wherein the performing the first sub-verification comprises:
determining that the first sub-verification succeeds based on the first digest value being equal to the second digest value.

4. The method according to claim 3, wherein the acquiring the first verification information comprises:
generating a first tree comprising a plurality of layers of features, wherein a lowest layer of features of the first tree comprises a plurality of digest values of a plurality of first transactions in the first target block, wherein the plurality of first transactions comprises the first target transaction, wherein two adjacent features of at least one layer of the first tree are connected, and a feature of an upper layer is generated until a first root feature of the first tree is generated, and wherein the first root feature is the first digest value; and
acquiring first bypass features of a first path as the first verification information, wherein the first path is between a third digest value of the first target transaction on the first tree and the first root feature, and wherein the first bypass features are lower layers of features to which other features on the first path except the third digest value are connected, and
wherein the performing the second sub-verification comprises:
determining the third digest value;
determining a second root feature of the first tree based on the third digest value and the first verification information; and
determining that the second sub-verification succeeds based on the second root feature being equal to the first digest value.

5. The method according to claim 2, wherein the target consensus network comprises a first trusted execution environment that internally has a first security execution space and a first key, wherein the first security execution space forbids external access to the first security execution space, and wherein the one or more first blocks are encrypted with the first key,
wherein the acquiring the first target transaction and the first block header comprises:
decrypting the first target block in the first security execution space based on the first key;
acquiring a decrypted first target block; and
acquiring the first target transaction and the first block header from the decrypted first target block;
wherein the performing the first sub-verification comprises:
invoking, in the first security execution space, a first sub-verification contract recorded on the first blockchain; and
performing the first sub-verification based on the first block header and the second block header, and
wherein the performing the second sub-verification comprises:
invoking, in the first security execution space, a second sub-verification contract recorded on the first blockchain; and
performing the second sub-verification based on the first target transaction, the first verification information, and the first block header.

6. The method according to claim 1, wherein, the method further comprises:
acquiring first blockchain height information of the first blockchain; and
forwarding the first blockchain height information to a global consensus network, and synchronizing, by the global consensus network, the first blockchain height information to the local consensus network, and
wherein the transmitting the transaction result data to the subscription node comprises: transmitting the transaction result data to the subscription node based on the first blockchain height information received from the global consensus network being inconsistent with second blockchain height information received from the global consensus network last time.

7. The method according to claim 1, wherein the first transaction is acquired by a first relay node and is transmitted to the target consensus network by:
determining a transaction type of the first transaction;
keeping the first transaction in the local consensus network and recording, via the local consensus network, the first transaction in a second blockchain based on the transaction type being a non-target type, wherein the second blockchain permits external access to the local consensus network; and
acquiring and transmitting the first transaction to the target consensus network based on the transaction type being the target type.

8. The method according to claim 1, wherein the acquiring the first target block comprises:
setting a first blockchain height counter that is increased by 1 when one first block is added to the first blockchain;
acquiring, as the first target block, the one or more first blocks from a second block height of a second value of the first blockchain height counter, when the first target block acquired last time reaches a first threshold, plus 1 to a first block height of a first value of the first blockchain height counter, based on a first difference between a current first value of the first blockchain height counter and the second value; and
acquiring, based on a second difference between the current first value and the second value when the first target block acquired last time fails to reach the first threshold, but a time difference between a first time point that is current and a second time point of the first target block last time being acquired reaches a second threshold, a first block added within the time difference as the first target block.

9. The method according to claim 1, wherein before the acquiring the first target block, the method further comprises: receiving a first subscription request comprising a first subscription condition from the subscription node, and
wherein the acquiring the first target block comprises:
acquiring an added first block from the first blockchain; and
acquiring the added first block as the first target block based on the added first block comprising the first target transaction satisfying the first subscription condition.

10. The method according to claim 9, wherein the first subscription request further comprises a subscription deadline, and
wherein the acquiring the added first block as the first target block comprises:
determining, from the first subscription request, a valid subscription request whose subscription deadline does not expire; and
acquiring the added first block as the first target block based on the added first block comprising the first target transaction satisfying the first subscription condition.

11. An apparatus for processing a transaction of a blockchain, located in a target consensus network, comprising:
at least one memory configured to store computer program code; and
at least one processor configured to read the program code and operate as instructed by the program code, the program code comprising:
first acquisition code configured to cause at least one of the at least one processor to acquire an added first target block from one or more first blocks of a first blockchain, wherein the first block is generated by the target consensus network and is configured for recording a first transaction of a target type from a local consensus network, and wherein the first blockchain forbids external access to the target consensus network;
second acquisition code configured to cause at least one of the at least one processor to acquire a first target transaction and a first block header from the first target block;
third acquisition code configured to cause at least one of the at least one processor to acquire first verification information corresponding to the first target transaction;
upload verification code configured to cause at least one of the at least one processor to perform upload verification on the first target transaction based on the first target transaction, the first verification information, and the first block header;
fourth acquisition code configured to cause at least one of the at least one processor to acquire transaction result data of the first target transaction if the upload verification succeeds; and
first transmission code configured to cause at least one of the at least one processor to transmit the transaction result data to a subscription node for the local consensus network to acquire the transaction result data from the subscription node.

12. The apparatus according to claim 11, wherein the upload verification code is configured to cause at least one of the at least one processor to:
acquire a second block header of a block next to the first target block from the first blockchain;
perform first sub-verification based on the first block header and the second block header; and
perform second sub-verification based on the first target transaction, the first verification information, and the first block header.

13. The apparatus according to claim 12, wherein a block header of the first target block comprises a first digest value of a first block body of the first target block and a second digest value of a second block body of a second block previous to the first target block on the first blockchain, and
wherein the upload verification code is configured to cause at least one of the at least one processor to determine that the first sub-verification succeeds based on the first digest value being equal to the second digest value.

14. The apparatus according to claim 13, wherein the upload verification code is configured to cause at least one of the at least one processor to:
generate a first tree comprising a plurality of layers of features, wherein a lowest layer of features of the first tree comprises a plurality of digest values of a plurality of first transactions in the first target block, wherein the plurality of first transactions comprises the first target transaction, wherein two adjacent features of at least one layer of the first tree are connected, and a feature of an upper layer is generated until a first root feature of the first tree is generated, and wherein the first root feature is the first digest value; and
acquire first bypass features of a first path as the first verification information, wherein the first path is between a third digest value of the first target transaction on the first tree and the first root feature, and wherein the first bypass features are lower layers of features to which other features on the first path except the third digest value are connected, and
determine the third digest value;
determine a second root feature of the first tree based on the third digest value and the first verification information; and
determine that the second sub-verification succeeds based on the second root feature being equal to the first digest value.

15. The apparatus according to claim 12, wherein the target consensus network comprises a first trusted execution environment that internally has a first security execution space and a first key, wherein the first security execution space forbids external access to the first security execution space, and wherein the one or more first blocks are encrypted with the first key,
wherein the first acquisition code is configured to cause at least one of the at least one processor to:
decrypt the first target block in the first security execution space based on the first key;
acquire a decrypted first target block; and
acquire the first target transaction and the first block header from the decrypted first target block;
wherein the upload verification code is configured to cause at least one of the at least one processor to:
invoke, in the first security execution space, a first sub-verification contract recorded on the first blockchain;
perform the first sub-verification based on the first block header and the second block header,
invoke, in the first security execution space, a second sub-verification contract recorded on the first blockchain; and
perform the second sub-verification based on the first target transaction, the first verification information, and the first block header.

16. The apparatus according to claim 11, wherein, the program code further comprises forwarding code configured to cause at least one of the at least one processor to:
acquire first blockchain height information of the first blockchain; and
forward the first blockchain height information to a global consensus network, and synchronize, by the global consensus network, the first blockchain height information to the local consensus network, and
wherein the first transmission code is configured to cause at least one of the at least one processor to transmit the transaction result data to the subscription node based on the first blockchain height information received from the global consensus network being inconsistent with second blockchain height information received from the global consensus network last time.

17. The apparatus according to claim 11, wherein the first transaction is acquired by a first relay node and is transmitted to the target consensus network by:
determining a transaction type of the first transaction;
keeping the first transaction in the local consensus network and record, via the local consensus network, the first transaction in a second blockchain based on the transaction type being a non-target type, wherein the second blockchain permits external access to the local consensus network; and
acquiring and transmitting the first transaction to the target consensus network based on the transaction type being the target type.

18. The apparatus according to claim 11, wherein the first acquisition code is configured to cause at least one of the at least one processor to:
set a first blockchain height counter that is increased by 1 when one first block is added to the first blockchain;
acquire, as the first target block, the one or more first blocks from a second block height of a second value of the first blockchain height counter, when the first target block acquired last time reaches a first threshold, plus 1 to a first block height of a first value of the first blockchain height counter, based on a first difference between a current first value of the first blockchain height counter and the second value; and
acquire, based on a second difference between the current first value and the second value when the first target block acquired last time fails to reach the first threshold, but a time difference between a first time point that is current and a second time point of the first target block last time being acquired reaches a second threshold, a first block added within the time difference as the first target block.

19. The apparatus according to claim 11, wherein the program code further comprises receiving code configured to cause at least one of the at least one processor to receive a first subscription request comprising a first subscription condition from the subscription node, and
wherein the first acquisition code is configured to cause at least one of the at least one processor to:
acquire an added first block from the first blockchain; and
acquire the added first block as the first target block based on the added first block comprising the first target transaction satisfying the first subscription condition.

20. A non-transitory computer-readable storage medium, storing computer code which, when executed by at least one processor, causes the at least one processor to at least:
acquire an added first target block from one or more first blocks of a first blockchain, wherein the first block is generated by the target consensus network and is configured for recording a first transaction of a target type from a local consensus network, and wherein the first blockchain forbids external access to the target consensus network;
acquire a first target transaction and a first block header from the first target block;
acquire first verification information corresponding to the first target transaction;
perform upload verification on the first target transaction based on the first target transaction, the first verification information, and the first block header;
acquire transaction result data of the first target transaction if the upload verification succeeds; and
transmit the transaction result data to a subscription node for the local consensus network to acquire the transaction result data from the subscription node.
